(19) United States
(12) Patent Application Publication
(10) Pub. No.: US 2011/0168549 A1
(43) Pub. Date: Jul. 14, 2011

(54) OPTIMISED SUPPLY SOURCE AND STORAGE UNIT FOR CRYOGENIC POWER OR NANOHYDRIDE ASSISTANCE USING PHOTOVOLTAICS FOR ON-DEMAND ENERGY PRODUCTION SYSTEMS

(76) Inventors: Alex HR Roustaei, Villeneuve la Garenne (FR); Abdelmadjid Djemai, Deuil La Barre (FR)

(21) Appl. No.: 13/056,660

(22) PCT Filed: Aug. 12, 2009
(86) PCT No.: PCT/FR09/00999

§ 371 Date: Mar. 21, 2011

(30) Foreign Application Priority Data
Aug. 14, 2008 (FR) FR08 04598

(51) Int. Cl. C25B 1/02; B82Y 99/00

(52) U.S. Cl. 204/267; 204/242; 977/742

(57) ABSTRACT

The invention relates to a system that consists of a very efficient and optimized photovoltaic power supply that can be added as a complement to an on-demand hydrogen production assistance, power, and electricity unit as well as outputs adapted for a direct use. The system includes photovoltaic elements containing nano-crystalline polymers for forming super-efficient photovoltaic cells, and is paired with a cryogenic storage unit or assistance hydride storage unit or is used as a separate backup unit controlled by a driving system (FIG. 4). The system has a modular arrangement (FIG. 6), is intelligent (FIG. 5), has a high power output (FIG. 2a) and uses nanotechnologies (FIG. 1). Multiple choices are made available to the user in order to obtain a production contingent with the needs or a variable energy flow rate (FIG. 6) for hybrid, electric, or all-hydrogen vehicles or for low-consumption houses for direct use (FIG. 3). The optimization possibilities enable GPS location and operation control and programming using GSMs operating with dedicated services such as weather forecasts or satellites for controlling and dispensing electricity or power (FIG. 1). The system is compliant with regulations concerning environmental cleanliness and air pollution reduction, and is adapted for complementing a power generator for use in the housing and transportation fields, or more generally, any industry generating power or heat particularly by hydrocarbon-based means, or any environment requiring power for operating in a stationary or mobile mode. This application is an extension and continuation of an alternate patent application with internal priority claim of a first invention patent application Ser. No. 08/030,19, filed on Jun. 2, 2008. The present application is a continuation of patent application Ser. No. 08/030,19 (PCT-FR/2009/000622, du 28 May 2009) which has been entirely appended for reference to and integrated into the present invention.

This application is a patent application under the PCT Pub. No.: WO/2010/018325 of International Application No.: PCT/FR2009/000999, Published on 18 Feb. 2010, with International Filing Date of 12 Aug. 2009, and domestic priority claim with the internal priority of a first application for a patent number FR08 04598, filed Aug. 14, 2008. The entire application PCT/FR2009/000999 as well as FR08 04598 are restructured and incorporated into this new application for patent by cross-referencing.

This application is also an extension and continuation in part of an alternate patent application with internal priority claim of a first invention patent application Ser. No. 08/030,19, filed on Jun. 2, 2008. The present application is a continuation of patent application Ser. No. 08/030,19 (PCT-FR/2009/000622, du 28 May 2009) which has been entirely appended for reference to and integrated into the present invention.

### INTRODUCTION

Hydrogen can be used as fuel to run a vehicle. The first addition to the application Ser. No. 08/030,19 would be to dispose energy at will and thus to have a means of storing hydrogen. Indeed, storage of surplus of energy as hydrogen becomes an additional benefit that will provide greater comfort in automotive applications. It is therefore possible to store all or part of the excess hydrogen produced in the invention Ser. No. 08/030,19 in a storage system. We envision this to be a cryogenic storage unit or a nano-hydrides because the performance of energy storage in hydrides and nano-hydride has increased in recent years.

A second aspect of this invention is the use of solar energy used to supply a power generation system equipped with Electrolyzer(s) Nanotic(s) described in the application Ser. No. 08/030,19 filed Jun. 2, 2008. This patent application also makes improvements in certain aspects the patent application Ser. No. 08/030,19.

This application is an extension and continuation in part of an alternate patent application with internal priority claim of a first invention patent application Ser. No. 08/030,19, filed on Jun. 2, 2008. The present application is a continuation of patent application Ser. No. 08/030,19 (PCT-FR/2009/000622, du 28 May 2009) which has been entirely appended for reference to and integrated into the present invention.

Provided that an “Electrolyzer is generally composed of at least one electrolysis cell comprising a vessel containing an electrolyte (a substance or compound that, in liquid or as a chemical solution, allows the passage of electric current by moving ions.) which are immersed two electrodes connected across a DC generator, or provided no system of monitoring and control and which produces gases; and a “Nanotic Electrolyzer is an electrolyzer as described above but with at least one nano scales based materials or carbon composites or nano tubes, such materials include a nano metal of 50 nm or carbon nanotubes, collectively called nano elements, which are the subject of the invention Ser. No. 08/030,19, filed Jun. 2, 2008.

The photovoltaic effect involves the production and transport of negative charges (electrons) and positive (holes) under the effect of light in a semiconductor material. Recently, a new concept based on the use of a thin film of the mixture of a conjugated polymer and fullerene-buckminster (molecule shaped soccer ball made of 60 carbon atoms, C60) has improved from significantly the performance of plastic photovoltaic devices using organic compounds.

The photo-physical study has shown that electron transfer to the origin of the photocurrent is competing with energy transfer does not lead to the formation of charges within the thin film, the second phenomenon is predominant. In photovoltaic devices, only a small fraction of light absorbed effectively led to the species to separate charges. Thus, the device performance is limited because much of the absorbed light is somehow lost due to the transfer of energy.

Furthermore, existing solutions are limited by their production costs, yields and inefficiency in capturing solar energy in a maximum possible spectrum as well as their lack of optimization.

For memo we note that the application Ser. No. 08/030,19 filed Jun. 2, 2008 mentions the following:
“Given the urgency of the situation, to replace oil in the medium term, we need solutions from already validated for the production of hydrogen and have compatible sources in the medium and short term.

Firstly, hydrogen exists in very small quantities on Earth. For this reason, it is necessary to produce hydrogen from; for example water (electrolysis) or any hydrogenated chains such as alcohols, natural gas or fuel (the reforming reaction). Our research for a clean, efficient, low cost energy, has led us to seek a means of converting water into energy with zero emissions of harmful gases”.
“An appropriate solution to the challenges of climate change and depletion of fossil fuels leads to the use of a source of cleaner energy in better conditions, with suitable options to best to equip our transportation and our means of producing electricity and heat in habitats within the constraints related to environmental protection”.

### AREAS OF USE OF THE INVENTION

The invention is intended to provide an optimized power supply to operate a power generator as an electrolyzer, generating oxygen and hydrogen in the automotive sector and a hydrogen fuel cell capable of providing electricity in the housing sector and hydrogen, hybrid or electric cars. The use of a power generator based on this invention is simplified by the consideration of the devices that will make it suitable for wider use in upstream and downstream of the Nanotic unit 1-3 (FIG. 1) (elements in nanoscale also called NANOTIC”) in the automobile sector to ease migration for easier in future years to see hybrid cars electric vehicles or hydrogen only cars.

The distribution of electricity in the new habitats as low energy houses can be coupled with a GPS tracking system and monitoring and remote control by means of GSM him different functions of energy storage with Orders received by dedicated services such as weather. Such a goal can be achieved by drawing on techniques used to date as described in particular in WO 2007/080369, WO 2005/038949, WO 2001/086734, WO 2001/084645, WO 2001/084644, WO 2007/028036, WO 2007/011741, WO 1998/058010, WO 2008/092490, WO 2008/077465, WO 2008/077465, and WO 2003/015189.

Indeed, none of these inventions allows production of electricity at high efficiency photovoltaic cells. As a result, the achievements have been limited to applications with low performance or specific and expensive. They are unable either to operate in both the visible and invisible light rays.

Again, the solution to meet this demand cannot be achieved by drawing on the techniques used so far for the production of electricity through methods such as described particularly in WO 2003/098715, WO 2008/067024, WO 2008/060683, WO 2008/037658, WO 2007/125867, WO 2007/125695, WO 2007/104547, WO 2007/098021.

Indeed, none of these inventions allows production to demand and recycling of hydrogen and oxygen not consumed by their reintroduction into the chain of Light on Water-Gas-Water is another element in this totally new application.

### STATE OF THE ART AND PRIOR ART

The problem of hydrogen storage is that under normal conditions, hydrogen is gaseous and has a density of 0.09 kg/m³. So in these conditions for a vehicle has a range of at least 100 km, the required mass of hydrogen would be 1 kg, a volume of hydrogen of about 11 m³ (11 000 liters). The tank should have the dimensions of a cube approximately 2.5 m side!

One way to reduce the volume of a gas is cryogenics. The liquid hydrogen has a density of 70.8 kg/m³, in these conditions, the tank needed to store “our” 4 kg of hydrogen would be 60 liters or the volume of gas tanks of cars today. However to be in liquid, hydrogen must be heated to a temperature of −240/−250° C.! So, to be used, such tanks shall be equipped with significant secondary systems to maintain the hydrogen at this temperature and to limit losses by vaporization.

The class of hydrides is the family of compounds that contain hydrogen and that it has a negative bias relative to the element of compound to which it is linked Hydrides can be classified according to the nature of the main link between hydrogen and another element. The hydrides are called covalent bond is when the covalent type. This is where the most common hydrides such as water (H2O), ammonia (NH3), methane (CH4). Metal hydrides are called when the link is to the metal type.

For this method to be useful it must be possible to develop materials with large surface areas. The use of carbon nanotubes (e.g. C 60) was also considered but one of the main obstacles today is that they absorb hydrogen only at very low temperature (−196° C.). In all cases, the current results are still too fragmentary to be able to predict their future.

Several pure metals or alloys can absorb hydrogen in their midst. The metal compound acts like a sponge for hydrogen. In metal hydrides the hydrogen is stored in atomic form (H) rather than molecular (H2) as in the previous tanks. The absorption of hydrogen (also known as hydrogenation) can be done through the gas (H2) dissociated into two atoms of hydrogen (H) at a temperature and pressure data and characteristics of the absorbent material. The absorption of hydrogen can also be performed at room temperature and pressure by electrochemical and specifically by electrolysis of water.

The storage capacity of metal hydrides can be very important since the alloy Mg2 FeH6 “stores” 150 kg of hydrogen per m³. A tank of 26 liters would be sufficient to “our” 4 kg of hydrogen. Nevertheless, the volume density is not enough, it is necessary that the alloy absorbed hydrogen can desorb the (release), in acceptable range and conditions. Indeed, for use in mobile applications, metal hydrides are considered to have temperatures and equilibrium pressures compatible with the said application (between 1 and 10 bar pressure, between 0 and 100° C. for temperature).

Several families of hydride intermetallics alloys are contemplated and considered: the AB 5 (LaNi 5 . . . ) and AB2 (ZrV2) and A2B (Mg2Ni) . . . It should be noted that alloys derived from LaNi 5 alloys are used in rechargeable nickel metal hydride (Ni-MH) several million units sold worldwide each year. The principles of storage and release of hydrogen are different in the case of complex hydrides of what they are for metal hydrides. Indeed, storage is done for first during a chemical reaction and not by “mere” occupation of “empty” structure as in the case of metal hydrides. For the sodium Alanate, the release mechanism of hydrogen is as follows:

6 NaAlH₄->2 Na₃AlH₆+4Al+6H₂->6NaH+6Al+9H₂

other types of hydrides can be considered. For example the family of amino-boranes (NHₓBHₓ) is a promising since they can theoretically absorb more than 20% by mass. The compound NH₄BH₄ can absorb 24.5% by weight but is unstable above −20° C. which makes it impractical. For the compound NH₃BH₃ cons (20%) is stable under normal conditions and requires moderate temperatures to release hydrogen, which makes it potentially more interesting.

Professor Shin-ichi ORIMO of the Institute of Materials Research of Tohoku University has developed in collaboration with the Japan Steel Works Company a tank the size of a matchbox can release up to 9 liters of hydrogen. The hydrogen is stored in an aluminum tank in the form of aluminum particles hydrogenated molecule developed by the research group. When heated to 80° C. the compound releases hydrogen as a gas. Experimentally, it was able to extract 9.3 liters of hydrogen from a tank measuring 4 cm×6 cm and a thickness of 5.5 mm

This represents a capacity greater than 43% over Lanthanum-Nickel alloy (LaNi 5) usually used for storing hydrogen. The group hopes to improve the properties of the system so that aluminum released hydrogen gas at 60° C., allowing direct use of waste heat from electronic devices and therefore a fuel cell powered portable instruments such as phones or computers. Once the hydrogen was released, it remains only aluminum. This process is irreversible; the tanks would be used as single-use cartridges.

All the solutions mentioned can be used as a means to support optimized to store excess hydrogen and release it on demand as described in the application patent Ser. No. 08/030,19.

In generators of electricity using photovoltaic technology, device performance depends in effect on the morphology of thin film placed between two electrodes. The separation of photo-induced charge at the origin of the photocurrent cannot be done at the interface of the contact zone between the two components (in the case of C 60).

To optimize the performance of photovoltaic cells, it is necessary to both promote the formation of charges within the thin film photovoltaic device and increase the amount of light absorbed. One major advantage of this new approach is the possibility of establishing a relationship between the structure of the hybrid compound and its activity. It is then easy to vary the structure of the molecule to modulate its electronic properties to favor the production of photocurrent. We note that the use of nano-crystalline polymers greatly increases the efficiency of photovoltaic cells.

Indeed, we can get a yield of 11% by stacking two cells DSC (Dye-Sensitized Cells or Cells sensitized on inorganic substrate) to form a tandem DSC cell, thus increasing the conversion rate. The top cell absorbs light in the visible, the bottom cell in the near infrared and infrared. The colors used are red-red dye or substrate (N719), which has an absorption peak at 540 nm (green) and black or black substrate-dye (N749) whose peak is 600 nm (orange), but that absorbs up to 800 nm (near infrared). The photoelectric conversion of low wavelength provides a high voltage and the long wavelength providing a high current, while explaining the high conversion obtained.

Recently, the French teams of the INL (Institute of Nano Technology Lyon) achieved conversion efficiency close to 18% measured on a second generation of photovoltaic cell crystalline silicon thin. At a time when 50% of the cost of crystalline silicon solar cell is due to the substrate, many researches focuses on cell-called second generation, thinned substrate. Although this reduction in thickness degrades the performance of conventional solar cells, new architectures can help conserve significant efficiencies as demonstrated Pierre Papet during his thesis entitled “New Concepts for the realization of solar cells with back contacts on substrates thin crystalline silicon.

His work presents the main studies and improvements to cells made of crystalline silicon on substrate type “p” of about 150 microns thick. Passivation of the front is ensured by depositing a single layer of hydrogenated silicon nitride on the micro-structured surface previously. On the rear, a deep and heavily doped emitter is achieved by diffusion of phosphorus. Repulsive fields produced on the back by doping with boron can limit recombination. Finally, the cell efficiency is optimized by the geometry of the metal contacts interstitial fingered deferred at the rear. All of these studies have achieved high efficiency cells and one of them has an efficiency of 17.9% (measured in the laboratory). This result is currently one of the highest conversion efficiencies achieved on silicon in a French laboratory.

Extract from the application Ser. No. 08/030,19 Filed Jun. 2, 2008 Mentions the Following:

The development of hydrogen as a future energy will require a strong shift towards sustainable production and an increase in the volume of production. The main methods of hydrogen production today are based on the catalytic reforming of hydrocarbons from fossil fuels such as natural gas (methane and light alkanes) and gas derived from petroleum (LPG) or coal. These proven technologies for stationary applications require today large scale, new research efforts related to the emergence of new applications and/or constraints. This is the case of natural gas conversion into synthesis gas (CO and H2) on the extraction sites or the generation of hydrogen as fuel for fuel cell vehicle applications (e.g. electric vehicles, power supply for laptops) or domestic (e.g. Stationary electricity generators).

These applications in a short and medium term have introduced lines of research and innovative technological breakthroughs such as the miniaturization process (new technology of mini-and micro-reactors/heat exchangers, co-generating heat and electricity) or Ultra hydrogen purification before entry into the fuel cell or storage reactors.

Hydrogen production by electrolysis of water, very marginal at the global level, appears first as a non-polluting process but in fact poses the problem of the origin which is the need of the electricity. Other alternatives are also subject of active research such as using concentrated solar energy as a source of heat at high temperature and organic decomposition of water by algae and, or bacteria. Technological difficulties (solar energy) were having extremely low yields (including biological processes), however, the use of these new synthetic routes to applications, seem to be very long term marginal.

The use of hydrogen as a fuel is an additional attractive method to improve engine performance and reduce automobile emissions. A mixture of hydrogen and oxygen GEH (Hydrogen Enriched Gas=H2+O2+Steam Fuel) produced by a new type of electrolyzer was recently introduced.

We often speak of electrolysis linked to the use of renewable energy. It would be interesting if the production of electricity in this way is not truly simultaneous to the needs. The other possibility is to use electricity generated by nuclear power plants (especially during the no peak hours). The hydrogen would store electricity in chemical form and later hydrogen can be used as an energy source.

As already mentioned, the efficiency of electrolysis cannot exceed 50%, even thus in theory we can cope close to this number. But its cost is much higher than reforming because of the cost of electricity. For the process to be profitable, we need low-cost electricity. But the interesting point would be in site production or in site assistance.

Typically, the electrolytic cell consists of two electrodes (anode and cathode), an electrolyte and a current generator. We have the following reactions:
At the anode, water is dissociated into oxygen and protons. The electrons go through the circuit.
At the cathode, the protons recombine with electrons to yield hydrogen.

By applying the current, water is dissociated into hydrogen and oxygen.

It is necessary to provide electrical energy as the enthalpy of dissociation of water is 285 kJ/mole. This corresponds to a theoretical potential of 1.481 V at 25° C., but in practice, we have rather a potential between 1.7 V to 2.3 V.

The dissociation of water molecules into di-hydrogen and di-oxygen gives:

H2O→H2+½O2Eo=1.229 V.

Overall, we 2H2O(I)→2H2(g)+O2(g)

Data on industrial electrolyzers provide the following information:
For a temperature of 80° C. and a pressure of 15 bar, we need about 4.5 kilowatts to produce 1 Nm3 of hydrogen (Currently, electrolyzers with an output of 1 to 100 kW are developed).
For this technology to be valid, it will be necessary to analyze both the economic but also environmental and energy on the whole life cycle, and to assess the costs of hydrogen production and the impact on the environment. These results depend largely on the type of electricity used and its cost.

Outcomes of R & D are fairly well identified.

They involve:
New materials: electrodes and catalysts in cheaper materials;
Electrolytes at higher temperature (Solid Oxide Fuel Cell-SOFC, Fuel Cell and Solid Oxide) or lower (Proton Exchange Membrane Fuel Cell, PEM Fuel cell or proton exchange membrane);
Direct use of methane as fuel, which remains an avenue to explore;
Thermal management and dynamics of the device and its behavior in real situations.

One of the major goals is lowering the cost of kW (approximately [symbol] 20 k/h today to [symbol] 0.5 or [symbol] 1 k/h).

I) At present, electrolysis requires large quantity of electricity. It is also less efficient from the point of view of energetic efficiency: In fact; potential energy from produced hydrogen is only about 20% of electricity needed consumed. It is therefore relatively little used.

II) In fact, researchers have decreased their attention on these studies and electrolysis techniques because of all the problems most often associated with this solution that are heat and maintenance relating to deposition in the electrolytic cell. The use of different materials with a higher percentage of nickel in the construction of the electrodes did not increase the energy balance of the electrolysis technology.

III) Technology reverse of electrolysis of water (hydrogen fuel cell) comprising passing the hydrogen and oxygen in a catalyst for producing both water, heat and electrical current. Currently, costs remain high due to the use of precious material (platinum) in the realization electrodes.

### ADVANTAGES OF THE INVENTION

The present invention seeks to establish a cycle of energy production with zero emission of polluting gases upstream of the energy subject to patent application for invention Ser. No. 08/030,19, filed Jun. 2, 2008. As described in this patent, the exponential rise in power of energy production is directly related to the number of modules (or) in the electrodes (or) room (s) electrolysis.

Another goal of this invention is to provide a starting cycle power generation using photovoltaic cells.

Another aspect of the present invention is to provide a super-efficient photovoltaic system capable of operating in the visible and infrared light rays and thus generate electricity with efficiency above 25%.

Another goal of this invention is to provide optimized storage of energy in the form of hydrogen.

Another interesting aspect of this invention is to store electricity as cheap electricity generated by nuclear plants during off-peak or the parables solar thermal.

Another interesting aspect of this invention is to store electricity generated by wind systems or dams in the form of hydrogen.

Another goal of this invention is to provide an optimization system providing inter alia an order of failover storage mode to production mode at the request and at a distance by a GSM system.

Another aspect of this invention is to have a GPS tracking system coupled to the optimization system ensuring a dialogue and form controls based on the nomad community and weather conditions for the interpretation of a newsletter dedicated weather using its GSM system.

Another object of this invention is to provide a system for optimizing power at home for devices operating at low voltage DC form (low energy houses).

Other advantage of the present invention is to provide a system that increases the capacity of electricity generation with multipliers. Through a turbine-type hydrogen Quasi-turbine (combustion engine using a four-sided articulated rotor turning and forming an oval room volume increasing and decreasing during their rotation).

### DESCRIPTION OF THE INVENTION

The invention relates to a very efficient and optimized power system to be added into the unit of hydrogen production power and on demand electricity with outputs suitable for direct use. It contains elements based photovoltaic cells DSC or polymers to nano-crystalline forms, super-efficient solar cells, combined with a cryogenic storage unit or storage-based hydrides for assistance or as separate source of recharge (backup) controlled by a servo system with a modular layout, intelligent, high energy efficiency and using nano technology. Multitudes of choices are available to the user for a simultaneous production needs or variable flow of energy to hybrid cars or houses with low consumption for use directly. The optimization options for controls and operating programs using the GSM operating with dedicated services like weather satellites for the control and distribution of electricity or energy.

An innovative aspect of this application is its photovoltaic component. Indeed, the technical achievements to date have been either captured by the infrared (IR) or by catching the rays of the visible spectrum. Infrared Spectroscopy (IRS) is based on the absorption of infrared radiation by the material analyzed. It allows, via the detection of vibration characteristics of complex chemicals, chemical analysis of a material.

The principle of infrared spectroscopy (IR) is as follows: when the energy of the beam is close to the vibrational energy of a chemical bond, the latter absorbs radiation and is experiencing a decrease in the intensity reflected or transmitted at this wavelength. The spectral range between 4000 cm-1 and 400 Cm-1 (2.5 to 25 microns) are the energy of vibration of different molecules.

All the vibrations do not give rise to one absorption band, it will also depend on the geometry of the molecule and in particular its symmetry. For a given geometry, we can determine the active vibrational modes in infrared with the Theory of Groups. Therefore, to a material with a given chemical composition and data structure will match a set of absorption characteristic bands that identifies the material.

There are two types of infrared spectrometers: a scanning spectrometers and Fourier transform spectrometers FTIR. As part of this application we used the spec [symbol] Infrared spectrometry Perkin Elmer GSX-2 Fourier Transform (Michelson interferometer be [symbol] ) whose principle is known.

Indeed, the principle of Spectroscopy (FTIR) is the following: the IR beam, from the IR source (in our case, a tungsten halogen lamp producing radiation or NIR filament heated at 1350 K provides the radiation in the mid and far IR) either (i) directed to a microscope or (ii) to the Michelson interferometer which will modulate each wavelength of the beam at a different frequency. In the first case it is possible to choose the size of the surface to be analyzed and then perform measures in reflection or transmission. In the second case the configuration is macroscopic [symbol] because the beam is not focused. In the interferometer, the light comes on separation.

Half of the beam is then directed to the fixed mirror of the spectrometer. The rest passes through the beam splitter and is directed onto the moving mirror. When both beams are recombined, constructive or destructive interference may appear depending on the position of the moving mirror. The modulated beam is then reflected from two mirrors to the sample where removals occur and then arrives on the detector to be transformed into an electrical signal. The detector signal is displayed as an interferrogramm. That is to say signature intensity depending on the position of the moving mirror. This interferrogramm is then converted to an infrared spectrum (intensity of adsorption as a function of wavelength) by Fourier transformed. The integral intensity of an absorption band may be related to the concentration of the chemical bonds responsible for absorption. If we know the thickness of the layer, you can compare the amount of a chemical group presented in several samples.

As part of this invention we have used two methods: (i) Reflection and (ii) attenuated total reflection.

The first mode is used to determine the porosity of a layer. Constructive or negative interference between the incident beam reflected at the air-/porous Si and the reflected beam at the interface porous Si/Si mono crystalline, can be clearly observed on the layers with thickness (d) is less than or equal to thought. The refractive index layer (n) is determined from the reflectivity spectrum, considering the optical path difference between the two reflected beams. The conditions for maximum interference order k and k+N can be written as:

2dn=kλₖ

2dn=(k+N)λ_{k+N}

where λ_{X} is the wavelength corresponding to maximum of about x, k and n are integers, N—the number of interference maxima between and λₖ and λ_{k+N}

Thus, we obtain

$$n = \frac{N}{2 d} {( \frac{1}{{λ}_{k}} - \frac{1}{{λ}_{k + N}} )}^{- 1}$$

The average porosity can be estimated from these measurements of the reflectance using the effective medium models of Bruggman (equation correlating the reflection coefficient and the porosity of a layer) or Maxwell-Garnett (theories applicable to a stack of nanocrystals in three dimensions). According to the Brouggeman model, for example, the equation correlating the reflection coefficient and the porosity of a layer is:

$$( 1 - P ) \frac{( {n}_{si}^{2} - {n}^{2} )}{( {n}_{si}^{2} + 2 {n}^{2} )} + P \frac{( 1 - {n}^{2} )}{( 1 + 2 {n}^{2} )} = 0$$

Where P is the average porosity of a layer of porous Si, n_{Si} is the reflectance of single crystal Si. The principle of the second mode called ATR (Attenuated Total Reflection or the attenuation of the reflation Total) involves placing the sample to be analyzed on the surface of a crystal with high refractive index (Ge in our case, n=4) higher than the sample. The IR beam guided through the initial crystal germanium (Ge) and undergoing total reflection at the interface between germanium samples is directed to the detector. The guided beam is slightly disturbed by the existence of transverse wave called evanescentes. These penetrate a certain depth of the sample being in direct contact with germanium. Part of the evanescent wave energy is absorbed by chemical bonds and the reflection of the main beam is said to be attenuated.

Being very sensitive, this technique has helped us in the case of porous Si to identify and quantify the chemical bonds present on the inner surface of porous Si avoiding saturation of spectra in transmission system on the tractor or layers spurious peaks due to interference in steady focus on thin layers of porous Si.

The hydrogen concentration NH (mmolg-1) can also be estimated from the holdings of adsorption spectra using the relationship:

$${N}_{H} = \frac{1}{{Γ}_{s} {ρ}_{si} ( 1 - P )} {\int }_{hv} \frac{α}{hv} d ( hv ) = \frac{{I}_{s}}{{Γ}_{s} {ρ}_{si} ( 1 - P )}$$

initially applied to determine the amount of hydrogen in the neck [symbol] amorphous Si tasks where Is (cm-1) is the integrated absorption of the valence band, psi density of single crystal Si (2.33 g cm-3), P porosity of a layer of porous Si, α(cm-1) coefficient adsorption, and the phonon energy hv Γs (cm2 mmol-′) oscillator strength of valence bonds Si—H deter [symbol] born from the relationship originally proposed for amorphous Si

$${Γ}_{s} = 37.6 \times \frac{{I}_{s}}{{I}_{w}}$$

Its dependence on porosity of the porous layer analysis is also taken into account. Where Is and Iw are respectively the integrated absorption of the valence band and swing band (around 640 cm-1), measured experimentally.

Our measurements of hydrogen concentration performed by FTIR ATR-mode are in excellent agreement with measurements of quantity of hydrogen made by thermal desorption spectroscopy (TPD called MS) another technique for measuring the amount of atomic hydrogen. This method is based on the analysis of gas desorbed from the sample during sublimation. TPD MS coupled with mass spectrometry is a technique for quantitative analysis but destructive. It is relatively difficult to implement.

A molecule, an atom or a solid (becoming a system) can absorb energy from various sources: electromagnetic radiation, electronic rearrangements, exothermic chemical reaction, etc. It is then in an unstable excited state and its return to the ground state can occur in several ways: luminescence, energy transfer intra-or intermolecular quenching.

The luminescence results from the return of the system excited to a ground state by emitting a photon. There are many types of luminescence that are distinguished by the source system activation.

According to the Jablonski diagram, the photo luminescence phenomenon may be summarized into three stages: i) A photon energy Eex, supplied by an external light source such as a Laser or the lamp is absorbed by the system, allowing the passage of a fundamental energy state to an excited state S0 S2 ii) This excited state usually lasts a very short time, between 10-8-10-10 sec. Meanwhile the system undergoes conformational changes and is subject to multiple interactions with its environment. The energy of S2 is then partially dissipated and the system has the energy S1 (S1<S2); iii) The return to the ground state S0 is done by emitting a photon (and a phonon in the case of semiconductors indirect gap) with the energy Eem.

Due to the dissipation of energy during the excitation state, the re-emitted photon energy is lower than the phonon absorbed. The wavelength of the emitted photon is larger than the absorbed photon.

In a semiconductor we can identify three types of transition which we differentiate among those radiative (with photon emission) and those non-radiative. The transitions or radiative interband are also classified according to the pattern of bands of semi-conductor, direct and indirect transitions. In the first type, the radiative recombination takes place in a “direct”, while in the case of a transition of the indirect type of recombination takes place via the intervention of the phonon. To keep the total wave vector K tot of the transition.

Luminescence spectroscopy is a very interesting technique for the characterization of semiconductors as it is non-destructive. Note that all the characterizations by photoluminescence spectroscopy [symbol] piebald, made in this application have been made with the means Laboratories Pathophysiology of Lipids and Membranes and Physics of Matter. The spectro-fluorometer used was a commercial type PTI Fluorescence System (meter).

Moreover, solar cells sensitized by dyes are regarded nowadays as an alternative economy for photovoltaic conversion. In particular, cells with dyes based on spiro-MeOTAD seem promising in the development of solid organic solar cells ((solar cells in solid or solid-state Solar Device: SSD). We use the red filter dye -dye (N719), which has an absorption peak at 540 nm (green) and black-dye (N749) whose peak is 600 nm (orange), but which absorbs up to 800 nm (near infrared).

The photoelectric conversion of low wavelength provides a high voltage that of long wavelength providing a high current, while explaining the high conversion obtained. The efficiencies reported so far, reaching about 11% yields of conventional cells based on dye-liquid electrolyte (DSSC: Substrate sensitized solar cell Dye Sensitized Solar or Cell). Considering this risk (11% yield), we will describe the second part of this invention which will yield over 25%.

Indeed, recombination inter facial filler is an important loss mechanism in dye sensitized solar cells. This is particularly true in the case of SSDs (solid-state solar device), the solid medium carrier holes being less effective in reducing internal fields that are conducive to the recombination of carriers charge. The introduction into the carrier material with holes tert-butylpyridine (tBP) and lithium ion seems to be the most promising approach. Optical and electrochemical techniques such as spectroscopy, nanosecond laser spectroscopy and impedance measurements to characterize photovoltaic, were used to study the impact of these additives on the SSD. It was found that the lithium ion and TBP increase the open circuit potential of the SSD. At the same time, it shows that tBP reduces the output current. The interactions of the additives was studied and optimized their concentration in the spiro-MeOTAD (solar cells based on: (2,2′7,7′-tetrakis (N,N-di-p-methoxyphenyl-amine)-9,9′-SPIROBIFLUORENE)). The doping of spiro-MeOTAD, expected to improve the transport of holes, causes a significant increase in the recombination inter facial load.

The morphological properties of TiO2, especially the thickness of the layer, the particle size and porosity of the films play a bigger role in the case of SSD than in the DSSC. The penetration of the hole conductor into the pores of the TiO2 and the diffusion length of electrons are related to these properties. From this follows that the absorption of light cannot be controlled solely by the thickness of the TiO2 layer and the active surface area for dye adsorption. A larger collection of light for TiO2 thin films offer advantages for transporting loads and better penetration of the hole conductor in the network deTiO2. The N3 dye adsorption on TiO2 was improved by the introduction of silver ions, the efficiency of the cell could thus be significantly increased. The mechanism of this simple modification technique is the dye of silver ions that bind to the molecule organometallic dye by the ligand thiocyanate.

This allows the formation of bridges between the dye molecules. The beneficial effect of silver ions on the photovoltaic performance was not limited to applying the standard N3 dye or to the spiro-MeOTAD.

In our SSD tests using impedance spectroscopy. The photocurrent spectroscopy of the light intensity modulation (called IMPS) and the photovoltage spectroscopy of the light intensity modulation (called IMVS) were applied to a wide range of illumination intensity. For the range of light intensities used, the dynamic photocurrent response appears to be limited by the transport of electrons in the TiO2 nanocrystalline, rather than by the transport of holes in the spiro-MeOTAD. The diffusion length of 4.4 μm was found for electrons in the TiO2. This value is almost independent of light intensity, because the electron diffusion coefficient and the rate constant for electron-hole recombination vary both in the same manner with intensity but with opposite signs.

An innovative aspect of the present invention is based on a combination of techniques and DSSC with FTIR spectra of membranes separating visible and invisible. Indeed, the invention is to have a minimum of two rooms, each dedicated to a collection of photocurrent although specific components that constitutes it.

The incident beam entering the photovoltaic cell that characterizes the present invention enters a first compartment equipped with a filter that lets through the maximum possible visible light, while absorbing the maximum of IR (infrared).

The first chamber collects the visible photocurrents rays while letting the other rays through. The invisible IR rays are filtered by the second membrane and enter the second chamber in which are placed Nanotic structures in ascending order by size in relation to the membrane inlet. This provision is judiciously used to trap the incident rays. Indeed as we shall describe in what follows, the materials used (TiO2) arrive by trapping the beam incident to dramatically increase the efficiency of photovoltaic cells.

Another aspect of the present invention is the use of an organic photovoltaic cell more economical in its execution. Indeed, it is composed of an organic active layer between two electrodes such as Al and ITO (Indium tin oxide or indium oxide doped with tin end). A transparent electrode, typically ITO (anode, indium oxide and tin (In2O3) (SnO2)), is deposited on a transparent substrate like glass or plastic. For the cathode, aluminum is deposited by evaporation on the active layer. The organic active layer is composed of two materials, a carrier hole, and the other electron carrier.

The conversion of light into electricity by a photovoltaic cell can be summarized in organic 4 stages:
The absorption of a photon leading to the formation of an excited state of the organic material with the creation of localized electron-hole pair in strong interaction (exciton).
Dissemination of exciton dissociation to a site.
The dissociation of excitons and creation of free carriers.
Transportation charges (holes and electrons) in each of the organic materials and the collection of charges to the electrodes.

The absorption of photons by an organic material, chromophore and this material leads to the excited state but does not directly lead to the creation of free electric charges. It creates electron-hole pairs localized in strong interaction, such as Coulomb, commonly called excitons.

These excitons then diffuse to a site dissociation that is to say at the interface between the material carrier of holes and the material carrier of electrons. Each of the two materials present in the active layer has different energy levels (LUMO and HOMO, Highest Occupied Molecular Orbital or the molecular orbital in the highest and Lowest Unoccupied Molecular Orbital or the molecular orbital lowest unoccupied). At their interface, dissociation of the exciton can then be obtained by an electron transfer present in a higher energy level to a lower energy level, thereby stabilizing the system. These are electron donor materials and electron acceptor materials. For excitons, this dissociation can take place only if it has reached this type of interface (site of cleavage) during his lifetime.

In this case, the diffusion distance of an exciton limits the size of areas of the same material. The diffusion length of exciton must be the same order of magnitude as the size of areas of photoactive material in the active layer. If the exciton has not reached a site dissociation, it dies via a nonradiative or radiative emission and its energy is lost. The diffusion length of an exciton to an organic material is of the order of 10-20 nm.

Once separated charges they must be routed to each electrode. An internal electric field is created using asymmetric electrodes and allowing the holes to collect a bottom electrode work function and electrons to another electrode at high work function. The charge recombination during the transport to the electrodes must be limited to avoid excessive energy losses. The interaction of charges with other atoms (impurities) may also limit the speed of transporting loads and limit the current. A final step is to collect the charges to the electrodes.

The materials used in the active layer of organic photovoltaic cells can be polymers, Oligomers having “small molecules”. However, they must all possess a conjugated system, which absorb in the visible and create charges, then to transport them. Moreover, these materials should be easily implemented by wet (depositing a solution on a substrate) or by vacuum evaporation.

As stated in the operation of a photovoltaic cell must be able to transport holes to an electrode of the device and the electrons to the other electrode in order to inject charges into an external circuit. Two types of materials are needed: The materials carriers of holes and electron transport materials. By analogy with silicon, we speak respectively of material p or n. When mixed, one speaks of electron donor materials (p) and electron acceptor materials (type n).

Among the materials electron acceptors, there are derivatives of perylene (polycyclic aromatic hydrocarbon)perylene-3,4:9,10-bis(dicarboximide)perylene-3,4,9,10-tetracarboxylic-3,4,9,10-dianhydride (type crystals glycofurannique) or the C60. These compounds are mainly implemented by evaporation or vacuum sublimation. For implementation wet Wudl synthesized derivatives of C60 which by functionalization makes it much more soluble in common solvents. Among others, the PCBM (1-[3-(methoxycarbonyl)propyl]-1-phenyl-[6,6] C61) is now widely used in organic solar cells.

For electron donor materials can find oligothiophenes (a solid state polymerization), the phthalocyanine dye (synthetic) of copper. Polymers are also widely used as derivatives of p-phenylenevinylene (a conducting polymer) such as (poly[2-methoxy-5-(3,7-dimethyloctyloxy)-1,4-phenylenevinylene]MDMO-PPV) of polyfluorene(poly (9,9-dioctylfluorene_-co-bithiophene), F8T2) and polythiophene (poly (3-hexylthiophene, P3HT). Polymers are always shaped by the wet.

Different donor-acceptor pairs can be used to make photovoltaic cells as the energy levels of each are adapted to have a good transfer of electrons from one material to another. Mixtures of small molecule/small molecule can be achieved.

They are generally obtained by successive evaporations of each molecule or co-evaporation under vacuum. Mixtures of polymer/small molecule are well studied and now lead the best conversion efficiencies with the couple P3HT/PCBM. Mixtures of polymer/polymer can also be considered but they are still poorly developed today because of the difficulty in obtaining soluble polymers of n-type and allowing efficient electron transport.

The technical implementation is now favored by wet deposition. This approach would develop from the cells by printing processes “roll to roll” which would significantly lower the production cost of photovoltaic cells.

The mixture of these two materials (donor and acceptor), leads to two main technologies for organic photovoltaic cells. They differ in the morphology of the active layer: it can be either as a bi-layer or as networks interpenetrating. The first organic solar cells made of two layers consist of two materials; one donor and one acceptor, which then form a pn junction. The charge separation occurs at the interface between two layers.

In 1986, Tang obtained conversion efficiencies of 0.95% (AM 2, 75 mA.cm-2) with a bi-layer CuPc/PV (perylene-3,4,9,10-tetracarboxylic bis-benzimidazole) between ITO electrode and a silver electrode.

One major drawback of this bi-layer structure is that only 10-20 nm on each side of the interface involved in photovoltaic conversion. Much of the absorbed photon does not lead to the creation of free carriers due to limited diffusion distance, a distance of exciton dissociation sites too great. Conversion efficiencies of 3.6% have been achieved with a bi-layer of CuPc/C60 (AM 1.5, 150 mW.cm-2).

Another technology has been developed since 1992 by Sariciftci et al with a structure of the active layer interpenetrating networks with MEH-PPV (poly[2-methoxy, 5-(2′-ethylhexyloxy)-p-phenylenevinylene] and C60 or PCBM. This technology then leads to conversion efficiencies of 2.5% in 2001 (AM 1.5, 80 mW.cm-2).

In this case, the materials form two interpenetrating networks bi-continuous phase separation with optimal order of 10-20 nm. Each interface (site of dissociation of excitons) is at a distance of the order of the diffusion distance of an exciton. The surface of the interfaces is much larger than in the case of a bi-layer and this therefore allows the entire volume of the active layer to participate in the photovoltaic conversion. The morphology of such an active layer is crucial for the efficiency of the cell. This type of architecture can be obtained with mixtures of small molecule/small molecule, small molecule/polymer or polymer/polymer.

The best results are achieved today with a mixture P3HT/PCBM giving yields of 4.4 to 5% (AM 1.5, 100 mW.cm-2) or 5.2% (AM 1.5, 80 mW.cm-2).

Photovoltaic cells are characterized by current/voltage curve in the dark and under illumination.

In the dark, the cell does not produce current, the device is passive. Under illumination, the cell generates current and thus power. This power is the area between the axes at J=0 and V=0 and the JV curve. Operating point (Jmax, Vmax), it is at maximum power the device. Photovoltaic conversion efficiency is then obtained by the following formula:

$$η = \frac{FF \times {V}_{oc} \times {J}_{sc}}{P}$$

Where FF is the form factor, V_{oc} open circuit voltage, the J_{sc} current density of short circuit with P of the incident power.

The incident light is standardized to 100 mW.cm-2 under AM 1.5 solar spectrum which corresponds to taking into account the Earth's atmosphere and an incidence angle of 48.2°.

The open circuit voltage is the voltage measured when no current flows in the active layer. In devices of the type metal-insulator-metal, V_{oc} is determined by the difference in work function of each metal. In the case of the solar cell Voc is linearly dependent on the level of the HOMO of the semiconductor material electron donor and the energy level of LUMO of the semiconductor material, electron acceptor (related respectively to the potential of oxidation and reduction of each material). Brabec and studies have clearly shown Scharber this dependence for materials acceptors and donor materials.

Other factors also affect the value of V_{oc} as interfaces to the electrodes. Indeed, the pressure losses to the electrodes decrease the value of Voc. Surface treatment of electrodes or the addition of intermediate layers are needed to improve the match between the work function of the electrode and the HOMO or LUMO of the donor or acceptor material. Why the ITO anode was treated by techniques of plasma or UV ozone, or covered with a layer that transports the holes with a work function higher. The PEDOT: PSS (polyethylenedioxythiophene (conducting polymer)) doped with polystyrene sulfonate (polystyrene sulfonic acid) is then used for this purpose. This intermediate layer improves the quality of the interface with the active layer. The cathode is in turn modified by adding a layer of LiF between the organic layer and metal. This additional layer improves the Voc issued by the cells. The value of Voc is thus linked to the energy levels of each material and also at their interfaces.

The J_{sc} is the current density provided by the cell under short circuit (voltage across the cell equal to 0). The current density is determined by the product of the density of photo generated charges by the mobility of the material. We have:

$${J}_{sc} = \frac{ne μ E}{S} ,$$

Where n is the density of charge carriers (positive and negative), e the elementary charge) μ ambipolar mobility, E is the internal electric field, S the surface of the cell

If we have 100% conversion efficiency of photons into charge, n is the number of photons absorbed per unit volume. However efficiency is not at its peak. This efficiency can be measured by the measurement technique IPCE (Incident Photon to Current Efficiency or the photon incident on the current efficiency), which corresponds to the number of electrons collected in terms of short circuit on the number of photons incidents. This value is calculated for each wavelength using the formula:

$$IPCE = \frac{{J}_{sc}}{I \times λ} \times \frac{hc}{e} = \frac{1240 \times {J}_{sc}}{I \times λ}$$

where λ is the length of the incident beam (nm), J_{sc} density of short circuit current of the cell (mA m⁻²), I incident power (W.m²). Today's best cells with mixtures P3HT: PCBM have a maximum external conversion efficiency (IPCE) of 70%.

Another limiting factor in the value of Jsc is the mobility of free carriers in the active layer. It is not only related to the mobility of each material separately, but the mobility of mixed materials. That is to say that we must take into account their structure and morphology of the blend.

The form factor is defined by the following formula:

$$FF = \frac{{P}_{max}}{{V}_{oc} \times {J}_{sc}}$$

where Pₘₐₓ is defined as the product of Vₘₐₓ by Jₘₐₓ, the Voc is the open circuit voltage, J_{sc} to the current density at short circuit Jₘₐₓ and Vₘₐₓ values correspond to the point of maximum functioning of the cell.

The form factor is related to the number of charge carriers collected at the electrodes at different operating voltages. Indeed in the active layer, there is competition between charge transport and charge recombination. This competition is equivalent to the competition between the transit time of charges in the active layer “tₜᵣ” and their life time ‘τ’. Migration distance charges “d” is defined by the product of the mobility of charges by their transit time through the internal field of the cell “E” according to the following formula:

$$d = μ \times ttr \times E or ttr = \frac{d}{μ \times E}$$

To limit the recombination in the active layer and extract the charges to the electrodes, it is important to have tₜᵣ<<τ, therefore has a maximum mobility of charges.

On the other hand, the series resistances (contact resistance, resistance of the active layer) of the cell affect the FF.

The first uses of organic semiconductor materials have been demonstrated in the 1960s with the development of electroluminescent cells to anthracene powered by an alternating current. The low electrical conductivity of these materials limited the amount of emitted light, until the advent of new materials, polymers such as polyacetylene, polypyrrole and polyaniline in the 1970s. Heeger, MacDiarmid and Shirakawa showed that the conductivity of polyacetylene (organic polymer with high conductivity), insulating polymer, increased strongly (by a factor of 7) when it was exposed to vapors of halogen.

This was linked to doping of the polymer by oxidation and simultaneous insertion of halides. Work has been carried out since, with major advances in the field of photovoltaics since the 1990s with the work of Sariciftci, and development of semiconducting polymers such as poly (p-phenylenevinylene) and polythiophene. Today, there are several major classes of conjugated polymers.

Conjugated polymers can be used in many electronic applications (transistors) or optoelectronic (light emitting diodes, solar cells). As part of this innovation, we focus on polymers dedicated to organic photovoltaics.

Several properties of polymers, plus the fact that they are readily implemented, are essential for obtaining efficient solar cells: low gap, high oxidation potential and good charge transport. These parameters govern the values of Voc, Jsc and FF, which determine the efficiency of a solar cell. One of the crucial parameters is the increase in the absorption of photons to increase the photocurrent. This course can be obtained:
by increasing the thickness of the active layer (but this solution is limited by the reduced mobility of charge carriers and their short lifetime).
extending the spectral range of absorption materials and thus decreasing the HOMO-LUMO gap polymers.

The absorption of an active layer of a photovoltaic cell based on P3HT and PCBM, absorbs UV up to about 650 nm. In this case only 22.4% of the photons can be absorbed and converted into electricity. However the solar spectrum is maximum around 700 nm and extends to the near infrared. Improved performance is achieved by using polymers that absorb up to 800-1000 nm.

The solar spectrum and integrating the number of photons available for acquiring a cell of 250 nm to the length shown in the table are summarized below:

| Wavelength [nm] | photon flux [%] (250 nm) |
|---|---|
| 500 | 8.0 |
| 600 | 17.3 |
| 650 | 22.4 |
| 700 | 27.6 |
| 750 | 35.6 |
| 800 | 37.3 |
| 900 | 46.7 |
| 1000 | 53.0 |
| 1250 | 68.7 |
| 1500 | 75.0 |

These polymers with low gaps around 1.3 to 1.7 eV, could lead to sharp increases in yields if one follows the pattern Scharber et al. to achieve conversion efficiencies of 10% mixed with PCBM.

Several families of polymers have been synthesized showing a strong shift of the absorption spectra towards low energies. Different methods are used.

One method is to synthesize copolymers with chromophores that absorb at longer wavelengths such as fluorenone organic.

The presence of the carbonyl bond on PDOBTF (poly[(5,5′-(3,3′-di-n-octyl-2,2′-bithiophene))-alt-(2,7-fluoren-9-one)]) and PTVF (Poly[(5,5′-(bis-(E)-1,2-bis(3-octylthien-2-yl)ethylene]-alt-(2,7-fluoren-9-one)]) yields an absorption band at 550 nm and shift the absorption spectrum to 700 nm with the presence of C═O and the bond for vinyl PTVF. conversion efficiencies up to 1.1% are achieved in cells.

Another method is to graft donor motifs on the backbone of the polymer, for example on grounds rings thiophenes monomeres33-35. Many studies have been conducted on the family alkoxythiophenes (nanostructuring of polymers derived), eg poly(3-décyloxythiophène) and poly(3-octylthiophene-co-3-décyloxythiophène).

The grafting of alkoxyl groups, strongly mesomeric donors, led to a shift of the absorption maximum of 110 nm as compared to the P3HT film. The gap is decreasing from 1.92 eV to 1.60 eV. The conversion efficiencies in photovoltaic cells remain very low, <0.1%, due to a strong decrease in Voc. Other monomers containing groups mesomeric donors can be considered as alkylthiothiophenes.

Other studies show the use of diphenylthienopyrazines groups (shift of absorption spectra beyond 1000 nm in the solid state) the shift of the absorption spectra beyond 1000 nm in the solid state. The gaps are then of 1.28 eV for PBEHTT (poly(5,7-bis[3,4-di(2-ethylhexyloxy)-2-thienyl]-2,3-diphenylthieno[3,4-b]pyrazine)) and 1.20 eV for PTBEHT (poly(5,7-di-2-thienyl-2,3-bis (3,5-di(2-ethylhexyloxy)phenyl]-thieno[3,4-b]pyrazine)).

The conversion efficiencies are then 0.29% for PBEHTT mixed with PCBM and 1.1% for PTBEHT (75 mW.cm-2). IPCE values are 15% in the region of 700-900 nm (maximum plateau) but remain low compared to the 70% achieved with P3HT.

The fact of developing small-gap polymers broadens the absorption spectra and increase the number of photogenerated carriers. By increasing this number, it is potentially possible to increase the current delivered by the photovoltaic cells. Problems related to the decrease in V_{oc} or related to the morphology may still persist and limit the device performance.

The yield of a photovoltaic cell is proportional to the V_{oc} issued by the device. Or is the difference between the energy levels and especially between the HOMO of donor material and the acceptor LUMO of the material that governs the value of V_{oc}.

This was recently demonstrated by the work of Scharber et al. For cells developed with the current mixture P3HT/PCBM, the value of the Voc is around 0.6 V.

By increasing the difference between two energy levels, the value of Voc could be increased.

We must therefore develop materials acceptors low reduction potential (connected to a higher LUMO energy) and donor materials with high oxidation potential (connected to a lower HOMO energy).

For the PCBM LUMO level lies at −4.3 eV. Studies are conducted on the modification of C60 and PCBM to modify and increase the level of the LUMO of the electron acceptor material.

Regarding the donor material, P3HT, which is now the benchmark for solar cells, has an oxidation potential around 0.6 V. Any work of molecular engineering is required for the synthesis of polymers with high oxidation potential. But one should keep a low gap to keep a good efficiency of charge carrier generation efficiency and charge transfer. The objective is to increase the oxidation potential of polymers to 1 V or beyond.

Incorporating a slight twist in the polymer chain leads to a decrease in conjugation makes the polymer more difficult to oxidize. The oxidation potentials are then higher. Mention may be made based polymers P3HT but on the ramifications of giving bithiénylènevinylène yield of 3.1% (AM 1.5, 100 mW.cm-2) or even polyterthiophene (poly(2,2′:5′,2″-(3,3′-dihexylterthiophéne)) which have oxidation potentials higher than P3HT and Voc of 0.75 V (yield around 1%, AM1, 5, 100-mW.cm 2).

However, this twisting of the polymer chains can lead to a sharp decrease in the mobility of charges within the material also with a shift of the absorption spectrum to lower wavelengths.

Other avenues are explored further using chemical groups strongly attractors to increase the oxidation potential of materials. One of polymers developed by Svensson et al. PFDTBT gives the Voc of 1.04 V in a mixture with PCBM through incorporation into the skeleton of the pattern benzothiadiazole (complex nanostructure). The polymer then gives yields of 2.2%.

On the same model as above, fluorenes can be replaced by thiophene or cyclopentadithiophène.

Finally, one can also cite the work of Colladet et al. with the synthesis of polymers based on bis(1-cyano-2-thienylvinylène)phenylene. The presence of patterns cyanovinylène (triarylamine combined producing fluorescent state) helps us to increase the oxidation potential to 0.85 V.

Good mobility of charges must still be preserved. Indeed we must not lose current density which is earned in Voc.

Once the charges created on each of the materials, they must be transported and extracted in each of the electrodes. This requires that each material has good mobility of positive charges for one and negative for the other.

Polymers Donors should therefore include the least possible traps for the positive charges. This results in the synthesis of polymers regio-regular with a good combination and good relocation charges along the polymer chain Mean regional rate regularity regular sequences of asymmetric monomer units along the polymer chain The goal is to obtain a homogeneous spatial distribution of orbital frontiers, the HOMO mainly for the transport of holes, to limit the creation of potential wells, traps for positive charges.

Among the polymers having good mobility, P3HT is widely used in solar cells but also in the transistor. Indeed, in such devices, the mobility of charges is the key parameter. P3HT regio-regular polymers are one of the first high mobility (around 0.1 cm2.V-1.s-1). The regio-regularity of the polymer is very important to get good performance and it was shown that the mobility of the material could increase by a factor of 1000 when the rate of regio-regularity from 70 to over 98%.

The regio-regularity of the polymer provides a good organization of polymer chains between them which result in a π stacking and to obtain a lamellar structure of P3HT promoting charge transport.

Other materials containing thiophene or fluorene also have very good mobility. We can mention among others, poly (3,3′″-didodécylquaterthiophène) PK-12 developed by Ong et al. Motilities of 0.14 cm2.V-1.s-1 are achieved with this polymer transistor device. The elimination of certain side alkyl chains on the polymer backbone (compared to P3HT) and also eliminating the problem of regio-regularity enhances the crystallization of the material (crystallites 10-15 nm wide).

Always based on thiophenes, McCulloch et al. have synthesized a series of poly(2,5-bis(3-alkylthiophene-2-yl)thieno[3,2-b]thiophene) with alkyl chains, C10, C12 and C14. Mobility transistors are then obtained between 0.2 and 0.6 cm2.V-1.s-1. This material has properties of liquid crystal and allows the formation of large organized areas (200 nm) with a flatness very important system that facilitates the transport of charge.

Good mobility of charges in the material can limit the recombination of charges in the active layer and thus have a high density of free carriers. This property of the polymer led mainly to improve the FF of the photovoltaic device.

We note, for these examples that the morphology of the films of polymers plays an important role in the performance of materials. For good charge mobility are reached must be highly organized areas. The morphology of active layers will also be important in the case of photovoltaic cells to promote both the charge separation and charge transport.

The morphology of active layers of cells in interpenetrating networks is crucial to obtain good transfer and transport of loads and thus lead to high conversion efficiencies. Different parameters influence the morphology of polymer/PCBM, generally obtained from solutions (spin coating or flow to the squeegee). These parameters are:
The chemical structure of each material.
The ratio between the two compounds.
The solvent used to make deposits.
The concentration of solutions.
The deposition temperatures.
The post-deposition heat treatments.

These parameters can be classified into two broad classes that are the thermodynamic parameters and kinetic parameters. The thermodynamic parameters correspond to the nature and properties of the initial solution (material, the ratio between them, and the solvent-solvent interaction materials). For kinetic parameters, they are mainly involved in the formation of the film. This is the time of evaporation of the solvent, the crystallization of materials and post-deposition treatments.

All these parameters must be controlled to obtain an optimal morphology mixture:
Phase separation of the order of 10-20 nm (diffusion length of excitons),
Networks of each continuous highly ordered materials to facilitate charge transport.
Ideally, the morphology of a hetero junction cell volume is represented by a nested structure with 2 combs.

The active layer consists of two phases (donor material and acceptor material) as two interlocking combs in three dimensions. The size of the teeth of the comb for the photoactive material (in our case the donor material) must be of the order of the diffusion length of excitons namely 10-20 nm. For the other material, here the acceptor material, just to have a continuity of the comb. The ideal is to have the highest density possible columns of 20 nm diameter of the donor material that preserves a good morphology and continuity of the columns of acceptor material.

Many studies have shown for the mixture MDMO-PPV/PCBM (Hetero junctionPolymer/fullerene derivative), an important influence of solvent deposition on the film morphology and thus the conversion efficiency of photovoltaic cells. Using chlorobenzene instead of toluene to a mixture MDMO-PPV/PCBM, the conversion yields increased from 0.9% to 2.5%.

This improved performance is attributable to the decrease of the sizes of areas of both materials. With toluene, the size of ordered domains corresponding to the PCBM was about 600 nm, whereas with chlorobenzene it is only 80 nm. The difference here is certainly related to the solubility of each material in the solvent.

The observed differences in morphology may also be related to the rate of evaporation of the solvent during deposition. More specifically, it plays an important role in the film formation and structuring or crystallization of materials. It takes a relatively short evaporation time limit for the phase separation but long enough to facilitate the crystallization of materials.

It was shown that following the deposition rate and thus solvent evaporation, a film of P3HT alone could adopt different morphologies. It is remarkable that the P3HT tends to organize fibrillar form.

Nevertheless it seems that the higher the molecular weight of polymer, the higher it is difficult to obtain these fibrils by the method of spin coating. This technique is one that allows time for solvent evaporation, by chloroform, the shortest. In this case, polymer chains of large molecular weight do not have time to organize and the resulting film is nearly amorphous. Other techniques allow time for evaporation of chloroform longer and thus obtaining more structured films.

In the case of photovoltaic cells, significant differences in film morphology but also the performances of photovoltaic cells were obtained by controlling the time of formation of the active layers of P3HT: PCBM 20 s to 20 min

On the JV curves, the current density increases with time of film formation from almost 5 mA.cm mA. cm-2-10-2. THE CURRENTS ARE DOUBLE. Similarly, the series resistance and the FF is improved with increasing training time for movies. By correlating these increases with the evolution of absorption spectra, we notice a bathochromic shift (frequency shifts of absorption towards the red) and an increase in band intensities vibrio P3HT with increasing time of film formation. This change of absorption spectra reflects a better organization of P3HT chains in the film promoting the transport of charges and allowing an increase in J_{sc}.

The choice of solvent evaporation time and thus play an important role when the homogeneity of the active layers and structuring of the materials contained therein.

Another technique for controlling the morphology is the application of heat treatment on the entire device. This allows for a reorganization of the active layer between two electrodes. In the case of blended P3HT: PCBM, yields of 5% are achieved only after annealing the active layer between 100 and 150° C. for a longer or shorter important 6-8.

Morphology studies showed a higher crystallization of the two components after annealing with the formation of a network of P3HT fibrils connected.

The presence of highly organized domains explains the increases in current density delivered by the cells and thus improve their performance from about 0.5% to more than 4% conversion efficiency. Indeed, changes in the structuring of P3HT promotes good hole transport until mobility's of 0.1 cm2.V.

This change in structure is also observable in X-ray diffraction with a net increase of crystallinity of P3HT after annealing.

This increased mobility results in a cell by a sharp increase in J_{sc}. The annealing temperatures and times must be optimized according to the polymers, their molecular weights, the thicknesses of the films.

Apart from the need to increase the conversion efficiencies of cells, the stability of the devices is a crucial point for improvement. The active layer is very sensitive to air and oxygen and encapsulation techniques can limit the deterioration of materials. In this case, the polymer blends/PCBM (derived from fullerenes) are chemically very stable for several thousand heures69.

But even if the materials do not deteriorate, significant changes in morphology of the active layer causes a decrease in cell performance resulting in yields of about 1.6% after 200 h at 60° C. (2.8% initially). AFM and SEM studies (atomic microscope and scanning microscope) showed a strong migration of PCBM molecules and polymers under the effect of temperature and annealing time. The temperatures used are higher than the functioning of a cell, but it shows a significant phase segregation of each material.

Techniques crosslinking or stabilization of the active layers are necessary for the proper functioning of the cells to several thousand hours.

The concept of polymer “double cable” is to develop polymers where the pattern of electron acceptor (usually C60 or derivative, cable n) is covalently attached along a polymer backbone electron donor (p cable). This produces a “double cable” Donor-Acceptor.

After creation of excitons in the polymer backbone, the electrons are transferred and then transported by the grounds pendant electron acceptors (hopping transport). The holes are the ones carried by the polymer backbone (transport intra chain) This would allow control of the morphology at the molecular scale with an intimate mixture of the two entities without significant phase separation. However the passage of this ordered structure at the molecular level to the ideal structure in the material is not obvious.

Few double-cable polymers were synthesized and tested to date. It takes a fair balance between solubility and the possible implementation of the material, and reasonable rate acceptors of electron quite high. Today the best conversion efficiencies obtained are about 0.52% under illumination AM 1.5, 100 mW.cm-2 (cell 4 mm2) with double-cable polymers based on thiophene and C60 containing up to 56 wt % of units acceptors.

The morphology of active layers associated with this polymer shows a homogeneous film without aggregation but nevertheless significant phase separation to be bi-continuous networks. The current densities are then measured by 2.4 mA.cm-2 compared with 0.6 mA.cm-2 obtained with the same materials but in the case of a mixture of classical with PCBM.

The results obtained with these polymers are currently low but presage a significant contribution as to obtain a suitable morphology for photovoltaic. Ideally, we could consider a bi-continuous structure forming two networks as a cylinder of C60 in a polymer matrix of type p.

Another approach is the use of block copolymers. These compounds consist of two thermodynamically incompatible polymer blocks. These two blocks are linked covalently therefore immiscible. The use of such materials leads to the solid state to the spontaneous formation of domains of highly ordered phase separation on the submicron scale of the order of 10-50 nm. These organizations can be very complex.

These are mainly the molar masses of each of the blocks which direct the morphology of the film and then lead to spheres, cylinders or lamellae.

These dimensions of phase separation correspond to the dimensions required for high conversion efficiencies in the active layers of photovoltaic cells. In preparing block copolymers comprising a block electron donor and electron acceptor block, these materials could lead to thermodynamically stable morphologies, suitable for photovoltaic cells. Indeed one of morphologies called Gyroid morphology “refers to two bi-continuous interpenetrating networks; morphology called” cylindrical “is also close to the ideal morphology of an active layer of photovoltaic cells. The presence of a highly rigid class block conjugated these polymers in the family of rod-coil copolymers (stick ball or block copolymers).

Of the first polymers were synthesized with a block of poly (p-phenylene vinylene) (PPV) and a block of polystyrene (PS) functionalized with C60.

Depending on the solvent used to deposit and after heat treatment, the morphology of the film may lead to a honeycomb structure with the use of carbon disulfide or fields organized elongated (type fibrils) with o-dichlorobenzene. Tests were performed photovoltaic devices. Performance remains modest (J_{sc} of 5.8 μA.cm-2, Voc of 0.52 V, FF 0.23, under monochromatic illumination at 458 nm, 1 mW.cm-2) but the use of copolymers block shows a photovoltaic effect and improved performance in terms of current density compared to a classical mixture of two compounds (C60 and copolymer PPV-bP (S-stat-CMS)).

This invention organic photovoltaic cells, generates a maximum of charge carriers and there is a good electron transfer between the two compounds. The morphology of the blend is optimized for a good electronic transfer and a good charge transport to the electrodes by limiting recombination to their collection.

This feature is significantly enhanced by the fact that the polymer has:
HOMO-LUMO gap a little more than that of P3HT, which is to say around 1.7 eV.
An energy level of HOMO lower than that of P3HT to increase the difference HOMO (donor material)—LUMO (acceptor material) to increase the value of Voc issued by the photovoltaic cells.
Good hole mobility for current density delivered by the photovoltaic cells as high as possible.

The polymer must therefore be more difficult to oxidize more easily reducible than P3HT. It must also have a homogeneous spatial distribution of orbital frontier, especially the HOMO, to create a good relocation expenses without potential wells that trap the holes.

To do this, you should avoid if possible alternations between motives and reasons donors and electron acceptors facilitate the synthesis of homopolymers that are easier to obtain.

One way used, starting from the reference pattern that is the 3-hexylthiophene, is to graft a pattern A on the electron withdrawing thiophene to increase its oxidation potential. Different entities may be considered: —NO2-F—RF—CN.

On the other hand, we have seen that the morphology of the active layer of a photovoltaic cell is crucial for the proper functioning of the device to obtain high conversion efficiencies. Indeed, the mixture of both donor and acceptor materials must lead to two networks with interpenetrating bicontinuous phase separation of about 10 to 20 nm for effective load transfer. Each of the materials must also have an organization that promotes the transport of loads to obtain a high yield of extraction and collection of charges to each electrode.

We know that there are different techniques during the film deposition or post-deposition that promote the structuring of the active layer with areas held by each of the two materials in particular PCBM and P3HT. It can get very good performances in cells that can grow with active layers composed of P3HT and PCBM annealed at 150° C. for 5 minutes resulting in the formation of a fibrillar network of P3HT. The yields achieved are 4-5%. However, this annealing step is not necessarily compatible with the use of flexible substrates to produce the cells. Indeed, annealing cause deformations of the plastic and do not allow to obtain high conversion yields reproducible. For this, we realized the structure of the active layer of P3HT and mainly by an alternative technology before deposition.

Different methods of obtaining P3HT fibrils exist and who use, for example, evaporation of drop or deposit dip (dip coating). In the case of cells interpenetrating networks, it is necessary to codeposit two materials over large areas. This method had already been planned with polyalkylthiophenes (electrochemical polymerization) regular non-regional in 1993 by Ihn et al. for electronic applications. This technique allows obtaining optimal morphology without recourse to a heat treatment of the photovoltaic device.

Extracted from the application Ser. No. 08/030,19, filed Jun. 2, 2008 Mentions the Following:

The invention relates to a generator of energy in assistance or sole source with a high yield of on-demand gas and a simultaneous production to the energy needs.

Understanding of the present invention is simplified by its structure. It is a modular design that allows different configurations, each making different products, suitable for a given use, depending on the combinations used and according to the need and scope. We'll present the various aspects of this invention in the details for each important element of basic knowledge:

Matrix

a. Interconnections and interface modules

b. Control electronics and controls

c. Power interface module

d. Interfaces Screen Monitor

e. Main tank and pump

f. Tank and pump ion concentration

g. Bubbler (s)

h. Filtering system and associated circuits

i. Buffer stage

j. Sub Interface

Modules

k. Interconnections and interfaces with the matrix and/or other modules.

l. Electronics module card,

m. Nano metal electrodes,

n. Electrolysis chamber.

Monitoring and Control System of Command

o. Display message

p. Parameterization

q. Self-tests

r. Communication interfaces.

Output Use

s. Gas mixture or separated

t. Current

u. Voltage

The simplified principle of operation of hydrogen production to demand in this invention as described by the figures (FIG. 6) for stationary systems with a variant for embedded systems in a vehicle, for example (FIG. 6B).

This is a whole electrolyzer comprising:
A matrix generator has an electronic command and control
One or more modules electrolysis
Part converter
Part of user output

Matrix electrolyzer consists of several distinct parts:
Tank electrolyte, ionic strength and buffer tank
Electronic control and interface
Indicators mounting
Main pump systems with variable flow pump, pump and ionic concentration of the buffer stage.
Non-return valves
Bubblers
Dryer (or drainage system) of gas
Filtering system for the electrolyte,
Parts of cooling.
Hydrogen Fuel Cells
Releases secure gas
Output Power

The main reservoir of the matrix contains electrolyte of all the modules. For the generator which is the subject of this invention, we always determine a minimum volume that meets the constraint related to the power required and available space (case of mobile applications for example).

For our explanation we will consider that the required power has to respond to autonomy of 34 hours with a volume of 150 liters of gas per hour.

The volume calculation for a system composed of a matrix with a full tank of electrolyte of three (3) liters and at least one module with one (1) liter capacity gives then a full size of the matrix 22 cm in length (L) over 12 cm thick (P) and 20 cm (H). Likewise, similarly for the module is obtained with 5.5 cm in length (L) 11.5 cm thick (P) and 19.5 cm (H).

Taking into account the volume of a single module connected to the matrix, the production will be of 1285 liters of gas per hour, or 20 lit/min (based on a yield of 85%, corresponding to about 4 hours of operation at full regime). The inventors have noticed that 200 lit/hour of HHO gas was sufficient for the enrichment of GEH internal combustion engines (up to 4 liters of displacement).

For this quantity the autonomy of the system is to reach 25 hours.

The production of hydrogen is controlled by the electronic control board consisting of:
CPU, memory, program interfaces and electronic input and output.
Components for measuring current and voltage converters with.
Sensors and system security and control of polarity.
Control panel and connectors.
Interchange and energy converter.
Temperature sensors.
Ignition air call.
Various sensors and controllers.
Out of gas.

In the present invention, the “checkpoint” is characterized by the couple “Control-Command”.

1—Control: Typically an entry from a sensor to the electronic control unit.

2—Command: Mainly “output command from the control electronics to the destination part or device usually related to an action or sensor or display.”

3—The mechanical or actuator/regulator control himself managing a flow/flux.

The essential functions of control are:
Work conditions of the device asking for energy (oil pressure sensor in the case of a vehicle for example).
Checking the water level in the main tank.
Level control of the ionic concentration in the reservoir.
Level controlling of the buffer reservoir.
Control of level in bubblers.
Temperature control of the electrolyte of the reservoir.
Temperature control of the electrolyzer.
Temperature control in the cooling system.
Control level of pressure in the electrolyte reservoir.
Control level of pressure in the electrolysis module.
Control of the ion concentration in the main tank.
Control of voltage converter, current changes polarity and frequency.
Control of current in the hydrogen fuel cell.
Control of mixing pumps and cooling system.
Control and measuring system (for use in internal combustion engines, this task is performed continuously by the electronic control system while in the case of electricity, the system does not adjust the need for a cell conversion and storage is always charged).

To better understand this invention, we describe the production of an important element which is hydrogen.

At power up of the system, the electronic control performs a self test and verification of security settings; the electrodes in the electrolysis module are powered.

The simultaneous production needs and the flow of hydrogen is controlled by:
Current applied to the electrodes.
Pulse frequency determining the time of electrolysis
Control of Power “A” or more electrolysis chambers.
Buffer stage device.
Surface of the electrode.
Level of electrolyte.

Note that in the particular case of production of HHO stoechiometric mixture, the polarity change function of the system can be activated.

The electronic control unit continuously determines the flow rate of hydrogen by measuring the volume of gas produced by the flow meters installed at the outlet of the drainage system of gas and informs the user via screen display monitor. All important information can be viewed on the screen of the same monitor. This information is illustrated in FIGS. 7 and 9.

The electrolysis system module is composed of pipes that supplies and returns the pressurized electrolysis as well as all interconnection and gas return circuit. The connector modules provides the arrival and return of specific signals of the module itself and of its power as shown in FIG. 3D. Each module also provides a free passage of information from adjacent modules through an electronic card installed individually in the slot provided for this purpose. The electrolysis chamber is composed of a minimum of two (2) Nano nickel electrodes mounted “3D (three dimensional effect or Triple Nano Effect)”, in a fluidized bed electrolyte as shown in FIG. 12D which shows exponential increase of the gas production technique with a fluidized bed (fluidized bed design or “FBD”).

This technique involves the addition of some of the actual nanoparticles in the electrolyte. This third variable (third dimension Z with respect to X and Y axes defining the plane electrode) enhances the surface reaction by the fact that all suspended particles are added to the surface of the electrode in its third dimension.

Note that internal combustion engines used in transportation or in industry have the characteristics of producing greenhouse gas during their operations. The production of pollutant gases is increasing considerably when starting a cold engine.

The innovative solution provided by the inventors to solve this problem (when the invention is used in hydrogen assistance) is the use of information provided by the temperature sensor associated with an internal clock of the electronic control system. Indeed, one can easily determine the status of the engine when igniting (cold or hot engine) using a correspondence table between these two variables (Table configured to help reduce a product's use in areas or countries).

For example, a cold start at an ambient temperature of 10° C. requires a flow of hydrogen at the start more important than starting at an ambient temperature of 40° C.

Note that a decrease in the temperature of the combustion chamber reduces the nitrogen oxides (NOx).

An advantage of this invention is to separate hydrogen and oxygen from its production around the electrodes, which contributes significantly to the decreased production of NOx.

After starting the system, the electronic controls check at every instant the demand and adjust the flow of hydrogen by various techniques described in this invention. This production is based upon the need for gas with some additional production required for the servo functions (buffer stage device) that meets the case of acceleration for use in combustion engines at all time (servo feed-back).

An important point of the invention lies in the servo feedback system that controls the electrolysis with a flow of gas. At any given acceleration, the buffer chamber lowers the condensation cycle to meet the demand for any required temporary surplus of gas (for the combustion engine for example).

At each instant deceleration, the buffer chamber increases its “condensation cycle (unlike the hydrogen being produced in the reactor chamber before the order of decreasing gas is actually performed and stabilized in order to answer demand for temporary reduction of gas) to meet the demand by the internal combustion engine for example and that, before the system enters its normal cycle.

Indeed, the buffer stage responds effectively to requests for on demand (pick, stabilization, smoothing, or acceleration) of energy, and that absorbs at refusal (decrease, hollow surplus or deceleration) of energy. The “On Demand” produced Hydrogen responds to the simultaneous production of needs.

This advantage also overcomes the bearing to the time constant of the system caused by the inertia of the subset in the chain of production of gas by the electrolysis system. The volume of a buffer stage is directly dependent on the time constant of the electrolyzer.

Generally, in classical solutions; Hydrogen is provided by either the compressed hydrogen with the following implications:
Strengthening of the storage chamber,
Use a pump,
Increased consumption of the general assembly,
Management of change in pressure,

Or by solidification (metal hydride or nano-porous) with features including:
Volume with low pressure, therefore, less sensitive to fine tuning (careful management).
Instant Return of dissolved hydrogen (stored) in the body of materials, etc.
Absorption of surplus of hydrogen by the custom control electronics system.

All these constraints are resolved by the buffer stage as part of this invention.

Indeed, the requirement for simultaneous production is easily quantified by type of each application. For example, for use in hydrogen assistance in the transport sector on a 2-liter cylinder vehicle, the system is asked to respond to accelerations that are of the order from 5 to 10 seconds. This corresponds to a maximum volume of 250 mlit/s before the extra hydrogen of the electrolyzer is set at this capacity (about 3 seconds, the value of the constant time of the system). Similarly, during the deceleration phase, an absorption capacity of hydrogen production under way is to be managed.

So we need a storage equivalent of the same order (order of magnitude) as previously described for this phase, approximately 500 ml/s. Other events to control in these cases are the activation command of metal hydrides and their own time constant in each phase.

Note that a kg of hydrogen at normal pressure has a volume of 11 m3. As such, it may require a management of hydrogen pressure in the buffer stage. This makes it very difficult, if not impossible, to store in the state in embedded systems.

A major advantage of this invention is that the buffer stage uses no storage to fill all of these functions. Indeed, the electrolyzer produces separate hydrogen and oxygen.

As we have described, each gas is individually piped and its flow is individually controlled electronically. Understanding of the benefit is simplified by describing certain possibility of the electrolyzer:
An electrolyzer with a capacity of 1800 l/h of hydrogen is in the overproduction of 10% compared to its need for assistance is from 0 to 0.5 l/s, and will see a total production of about 0-50 ml/s max to manage.

So there is a surplus of hydrogen in the circuit to meet any demand in this period (or during the acceleration). Any unused surplus is immediately routed to the fuel cell provided with its tank conversion where oxygen is also sent in quantities necessary for production of H2O. This is pure water which is re-injected into the matrix's reservoir. This ingenious solution also allows controlling the ion concentration of the electrolysis.
Of course any deceleration or deny use of hydrogen already produced and waiting instantly increases the production process of the water. Any excess water is removed by a simple valve system output.

At any moment the workflow for each gas, allows instant response to requests in a point (function detailed in FIG. 5).

Indeed, in an application for assistance at the request of hydrogen for internal combustion engines, the need for hydrogen is a function of instantaneous speed, engine capacity and type of vehicle. The flow of hydrogen is then put to an initial value when setting up the system. This setting is usually done at the time of installation of the present invention.

These two (2) advantages of the present invention are important for safety and on demand production (at the request) of hydrogen. The flow is easily controlled and covers any gaps generated by inertia or a time constant of the system.

Note that:
1—In the case of HHO stoechiometric gas, the fuel cell (hydrogen cell) can be replaced by a cooling system. The condensation chamber takes water out of fuel cell (hydrogen cell) or re-condensation of excess gas.
2—The establishment of diaphragm 3B-4 (FIG. 3b) determines the separation of hydrogen and oxygen gases.

The innovative solution proposed in this invention will describe a SUPER EFFICIENT electrolyzer, greatly increasing the efficiency of electrolyzers. Indeed, among the types of existing electrolysis to generate hydrogen (acids and alkaline). Alkaline electrolysis is the most appropriate because it eliminates the need for expensive precious metals as a catalyst, and with a large area of Nano scale particles, the catalytic reaction is more efficient. For alkaline electrolysis, nickel is ideal because it is much cheaper than platinum and can easily be produced at the Nano scale. Nano-scale nickel also increases the area available for catalytic reaction that generates hydrogen, which increases efficiency and hydrogen production rates.

One advantage of this invention is its electrolysis chamber essentially characterized by:
its high efficiency (85%) of gas to the order of 1,285 lit/h,
its small footprint that is 5 cm long, 12 cm wide and 19 cm in height,
its ergonomics,
its robustness,
its ease of installation and integration in embedded version,
its modularity.

It becomes also simpler to consider configurations that allow control of electrode surface exposed to the electrolysis reaction (control level or surface exposure).

The module consists of:
1—The electrolysis chamber,
2—A minimum of two (2) electrodes,
   Anode
   Cathode
3—An electrolyte solution for the realization of the chemical reaction.
4—Input/output electrolyte, gas outlet,
5—Interconnection with the power supply.

The innovative solution used for the base module produces an average of 1285 liters/hour (l/h) with the possibility of controlling the amount of gas required at a given time “t”.

Indeed, because of the fluidized bed “FBD” electrolysis technology that allows for 3D reaction, and the Ni/Fe (Nickel/Ferrite) of very high surface area called “nano catalyst”. The fluidized bed can increase the electrode surface and thus reduce the current density of reaction between the fluidized bed and the other electrode.

Based upon a voltage of 1.59 volts and a current of 5 A/cm2, applied to the electrodes, we obtain a yield of 85%. That is around 1800 watts.

According to Faraday's law for a 1 kg of H2, we need 33,000 watts per hour, so a power of 1800 watts produces about 0.05 kg of H2. Under the normal pressure conditions and temperature, one mole of hydrogen has a volume of 24 liters of Consequently the volume of corresponding H2 is 600 liters.

To address the problem of surface electrodes in an electrolyzer, we use nano nickel powders (mixture of particles of 1 to 10 or 5 to 20 nm, coated with nickel oxide with a thickness of 0.5 to 1.5 nm).

The Low cost's of necessary nano materials to increase (about 1000 times) the catalyst surface of the electrodes, produce hydrogen directly from water and electricity with higher efficiency and greater production rate of hydrogen and oxygen gases. In the present invention, this highly efficient system is mounted in a compact module and is easily mounted in the matrix in the case of on demand assistance.

Another aspect of this invention is a nano-porous carbon filament and method of formation for use in the manufacturing of electrodes used also in hydrogen fuel cells. A mesopore formed on the periphery of nano porous filamentous of carbon is a pore tunnel type that is formed in the direction of a hexagonal arrangement of carbon from the periphery to a fiber axis. Said nano-porous filamentous of carbon is produced by selective removal of carbon hexagonal plane forming the nano filamentary of carbon via gasification using a catalyst after high dispersion of Fe, Ni, Co, Pt, etc., whose size is between 2 and 30 nm on the surface of filamentous nano carbon. The mésopore type tunnel is formed radially through a process of nano drilling The size of nano-porous carbon filament can be regulated depending on the size of the catalyst nano-drilling and nano drilling conditions.

According to methodologies explained in this application, we find that some materials produce a large metal surface. The reference electrodes are queues in Zinc or Nickel and the chemical solution is Eutectic KOH (33% aqueous). These new generations of electrodes, produce 75% more effective at low electrical currents while remaining reasonably efficient with stronger surface current.

The table below shows the effectiveness of nano metals based on a type of electrolysis.

| | Conversion | Conversion |
|---|---|---|
| Electrode Type | Efficiency (0.1 A/cm²) | Efficiency (1 A/cm²) |
| Nickel powder | 46% | 19% |
| Platinum Black | 67% | 42% |
| VH2 | 71% | 49% |
| MgH2 | 81% | 58% |

As described above, the perfect Nano conductors have high impedances. To take into account more impurities present in the environment, we introduced Dn as transmission coefficients associated with the nth mode of propagation and we obtain

G=Σn=1Dn2e²e²/h

Experimentally, we measure this resistance in a two-dimensional electron gas. To create impurities in the gas, we put a grid on the surface of the semiconductor, about 100 nm from the electron gas. A voltage applied to the grids used to constrain the gas and creates a barrier (by presence of an electrostatic barrier). The measure shows the plateau, linked to the apparition of a new mode of propagation in the device.

During this experimentation, we have also noted that there is more than 80% efficiency with porous nickel electrodes. This means that the use of Nano scale materials provides a horizon for the profitable production of hydrogen from water.

Studies in the United States, the specialized organization (Quantum Nano) show that a catalyst made using metal based Nano composites in an electrolysis reactor fluidized bed allows for the reaction in 3D (catalysis in a fluidized bed reactor or Catalysts in a Fluidized Bed Reactor “FBR”) that exceeds a rate of 5 Amps/Cm2 provides an efficiency of 93%. This is equivalent to 2 gge/hr/m2 (gasoline equivalent gallon of/hr/square meter) or 21 NM3/hr/m2 (Normal cubic meters per square meter) and 42 kWh/kgH2.

Note that other techniques such as membrane electrode used to produce hydrogen from water using heat (simultaneously hydrogen and oxygen in stoechiometric amounts). The heat source of the device described is the burning of a hydrocarbon using the porous burner technology. However, this device can be modified so as to exploit other sources of heat, including solar.

The recent availability of Nano metals on the market allows us to design a new set of electrodes made of Nano elements. The problem to address was the surface of the electrolysis.

Indeed, nickel 1 gr=0.6 cm, area of 1.12 cm² and 1 g Nano nickel 10 nm, represents an area of 67 m², which corresponds to 42 kWh/kg. So there is an exponential relationship of increasing the surface produces a jump to 87% efficiency (energy efficiency) and promises 93%.

Note that this technique can produce electrodes with Nano scale materials. There is an element to nano scales based materials or carbon composites or nano scale tubes, where such materials including nano metals from 1 to 50 nm or carbon nanotubes, generally called the nano components. On the surface of each is deposited a substantially continuous film of silicon nanoparticles (in the case of nanotubes, this film has a thickness ranging from 1 to 50 nm). Nano elements are arranged essentially parallel to each other and are secured by one end to a substrate and are arranged perpendicular (with of course, a substrate that is electrically conductive).

Process for preparing a material comprising Nano elements on the surface of each is deposited a substantially continuous film of nanoparticles of silicon, including a growth stage of Nano elements.

The present invention presents also an innovation in the electrodes used in the electrolysis chamber. Indeed, the use of new materials in the technique of electrolysis of compounded composed of carbon nanotubes and have particular advantages related to their electrical conductivity properties and increase their surface.

This gives a tube open at both ends, it remains to be close. For this we must introduce defects in the plane of curvature of grapheme, this is of pentagons.

These pentagons introduce a 112° bend in the chapter and the mathematical laws of Euler showing that a minimum of 12 pentagons to close the form (or 6 pentagons at each end of the tube) is needed. Studies show that the C60 molecule contains just twelve (12) pentagons and twenty (20) hexagone.

This represents the smallest possible fullerene. However, while a theoretical distribution of regular pentagons gives a hemispherical shape, there is usually a conical shape.

The nanotubes can have a very large length compared to their diameter (aspect ratio>1000). Subjected to an electric field, they will have a very strong peak effect (cf. principle of the lightning rod). With relatively low voltages can be generated at the tip of the huge electric fields is able to remove electrons from the matter and issue them to the outside. This is the field emission. This emission is extremely localized (at the end of the tube) and can therefore be used to send electrons on a specific spot.

Understanding of this part is simplified by the explanation of the manufacturing of an electrode-based pellets (cylindrical rods' compacted material), themselves based on nickel powder (micro nickel) tiny size (1 to 4 microns) mixed with 10% nano Nickel (1 to 10 nm). To achieve this we used the sintering technique (called sintering) (heating below the melting temperature) and compression of powdered nickel.

The electrode is connected to the cathode using a screen-based device such as platinum electrode and a diaphragm between hydrogen and oxygen based on “Cellophane (thin film composed of clear and hydrated cellulose). The flow of ions is at an angle of 90° to the surface of pellets and gas out of the same surface. So we need a liquid electrolyte in constant rotation to remove the gases produced to allow the electrodes to remain clear (Airjet removal or walled water).

FIG. 12B shows a net increase by a factor of 2000. FIGS. 12B and 12C also show that one can easily reach an efficiency of 85% with currents in the range of 3-300 mA/cm². The conversion of gge/hr/m² employed (Galon of gasoline equivalent per hour per square electrode) equals 125 000 Btu of H2 (about 1 kg of H2). Note that this technique produces a volume of hydrogen 100 times larger than the graphite.

A major advantage of this invention is its control system and flow control of on demand hydrogen (or electricity) production. An example of the use of hydrogen production assistance is in a motor at variable speed or torque ratio defined by power horsepower.

The limits of variation of hydrogen production are generally defined by its electrolysis' capacity. In the case of our invention we will consider a production capacity of 240 liters per hour max. This rate can vary from zero (0) to 250 l/h. Elements controlling this flow are:
1—The intensity of current (DC) applied to the electrodes,
2—The variation in the duration of this intensity,
3—The temperature of the electrolysis solution (electrolyte).

One way of gas flow control is the control of current applied to the electrodes. Replacing current (DC) by short current pulse is therefore considered. Several Control current pulse methods are used:
System for controlling the duration and amplitude of current applied to the electrodes through the electrolyte. A pulsed system was developed by Naohiro SHIMIZU, with a range of voltages between 7.9 to 140V with duration of 300 ns and a frequency of 2-25 kHz. It demonstrates that the short pulse current produces an electric field that helps the production of hydrogen without reducing the efficiency of the electrolyzer for electrolysis is produced using the technique of limited rate of electron transfer, while in DC current (DC) occurs following the technique of limited distribution.
Control system of an electrical impulse produced by pulses of high voltage direct current (20 to 40 KV) at frequency of 10-15 kHz (other Internet sources give 50 MHz and less than 1 mA).

The inductance in series with the primer capacity absorbs the resonances within the molecule. These have the effect of breaking the covalent bonds between atoms of hydrogen and oxygen, using very little energy. Both the gas and remain separated until sufficient energy is available to recombine to form water again. These key points are taken to create tension at the particle.

In the case of transport, flow control for the enrichment of hydrogen (EHG) is essentially important in a cold start.

Indeed, the most important pollution is produced during the three (3) first mile at first startup or after a prolonged (when traveling in urban areas with high population density). The present invention provides a solution by the fact that the controller is capable of making a decision on the debit based on the following:
1—Check/verification (measure) from the current output rate of the module (its flow meter)
2—Check/verification of the suction (intake of air)
3—Measurement of temperature

A decision on the increase or decrease the amount of hydrogen is then taken by the control module unit that controls and regulates the production of hydrogen and the flow.

Optimizing of the hydrogen flow will be done using a configuration of the system during the parameter setup of the invention. This setup includes the entry of the engine type (petrol or diesel) and cylinders of the vehicle.

In the particular case of habitat, flow control support for electricity using hydrogen is so automated and is managed by the control electronics.

It is important to note that a configuration of this invention can in combination with an internal combustion engine, used as a standalone generator.

Fuel Cell (or Hydrogen Cell)

Recently, the technology of fuel cells and their performances have made great progress with respect of the heart of the cell device. The first demonstrations in the field of transport should see real market applications within five years. But many locks should be removed before marketing, especially on a large scale. Components of heart of the cell require the synthesis of new polymer membranes, catalysts using no more platinum, membranes-electrodes assemblies that allow a guaranteed reproducibility.

Finally, the management of the fluid, temperature and electronic control of the application are truly to be optimized. Knowing that direct combustion of hydrogen is to promote a pathway initially to increase the fuels combustion efficiency and with their flaws of CO2 production (livre blanc CNRS).

Nano metals provide an answer to some of these expectations. As described in our invention during the explanation of the case of electrolysis, the increased electrolysis surface area allows for greater ability to exchange ions. Indeed, the hydrogen comes in contact with the pellet in electrode's nano metal.

This hydrogen is oxidized to form H+ ions and releases electrons. The membrane allows only H+ ions to pass. The electrons leave the cell and go into the electrical circuit. On the other side of the cell, H+ ions combine with electrons that have passed through the circuit to react with dioxygène O2 and thus form water.

It is an advantage of the present invention to use the gases produced to hydrogen fuel cells directly to the output of the buffer stage and:
Either to regulate the instantaneous flow of hydrogen,
Either to produce electricity to meet the needs voltage or current of a given application.

Note that with an efficiency of over 95% produced by the present invention and equipped with a hydrogen fuel cell with a footprint of 05×04×12 cm 3 (H×W×D) as described in FIG. 2A-13 (FIG. 2A) we can consider a direct use in combination with multi about this module to generate electricity.

Some features of this application are used to store gases in hydrides. Storage of small particle form of hydride (e.g. aluminum) hydrogenated frees gases that can quickly be used as batteries in electrical appliances or laptop.

The importance of energy consumption in homes/habitats is a hot topic and subject of present discussions. The CO2 emissions that come from it, drives the focus of research and thus it mobilizes an increasing number of researchers on ways of developing and reduction of dimensions of stationary models at various scales, on the understanding of human interaction on comfort scenarios involving immediate environment and finally on integration of new ideas, especially for the management and optimization of houses with renewable energy and geothermal energy. Indeed, residential and tertiary habitat is the biggest consumer of energy in France (46.6% of national consumption in 2OO2, while transportation represented 24.9%).

With a yield of 80%, power output is 80% of the input power 1800 watt/h recovered at the output of the electrolyzer and converted into electricity we get about 1500 w/h of power output.

Given that in general to produce 1 kWh of electricity from a hydrogen fuel cell, it requires an average volume of 800 liters of hydrogen per hour.

With one module connected, the electrolysis produces 1285 liters of HHO gas. Knowing that hydrogen occupies ⅓ of the volume, so its volume will be of 12851/3=428 liters/hour. In conclusion, to produce 1 kWh of electricity, we will have to connect 2 modules on the matrix as it will be 856 liters/hour (2×428 liters) of pure hydrogen.

An important benefit of this invention is the use of hydrogen fuel cells (note that hydrogen cell is often used to differentiate a fuel cell that uses H and O; where as a fuel cell is using any fuel/hydrogen and air) in a modular structure with multiple uses and shares the same technology of nano metals in the transformation cycle “Water—Gas—Water” with an efficiency exceeding 85%.

Note that for use of this invention with electricity outlet, the output can be equipped with a voltage stabilizer (UPS) that avoids unstable voltages generated by the connection/disconnection of appliances (control power capacity can be used to balance the current call caused by on/off switching of any appliance).

The main reservoir contains distilled water to which is added automatically a concentrated ion solution. The tank structure responds to stress corrosion itself.

One or more cooling solutions of the system can be integrated throughout. We use in this invention, the two systems of electrolyte circulation pump and system derived from vortex we called Walled Water.

### BRIEF DESCRIPTION OF FIGURES

FIG. 1 shows the blueprint of the components of the present invention in the field of housing. 2A and 2B respectively show the construction of the capture portion of the visible rays and the principle of capturing infra red solar cells used in this invention.

FIG. 3 shows the various systems intelligent energy-efficient used in the present invention.

FIG. 4 shows the different storage units used in this invention.

FIG. 5 shows the block diagram of the Nanotic electrolyzer used in this invention.

FIG. 6 shows the schematic diagram of the Nanotic electrolyzer used in this invention.

### DETAILED DESCRIPTION OF THE INVENTION WITH FIGURES

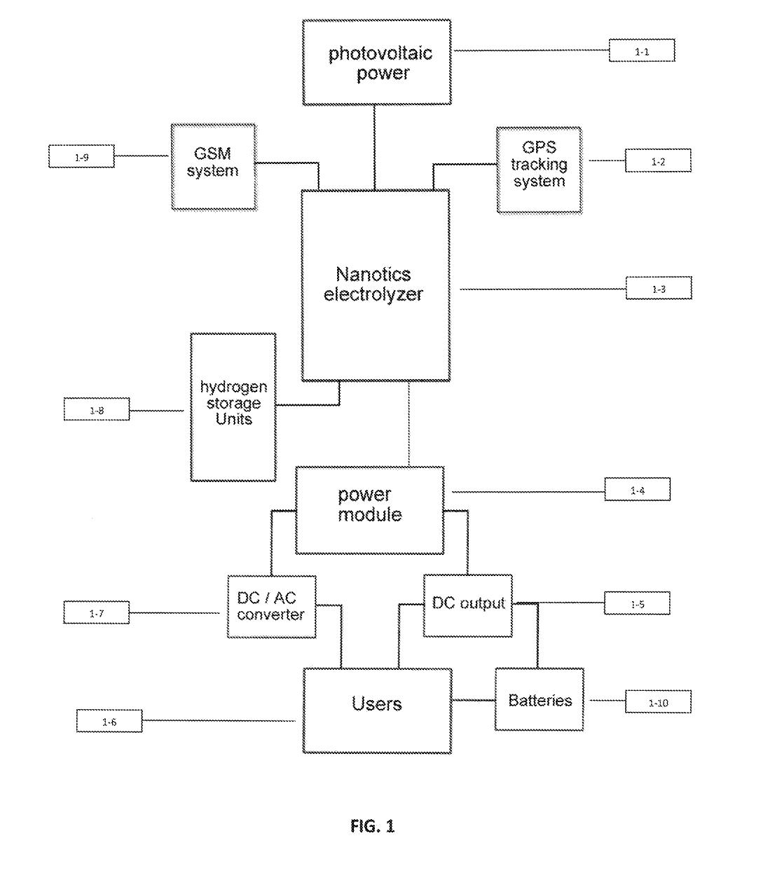

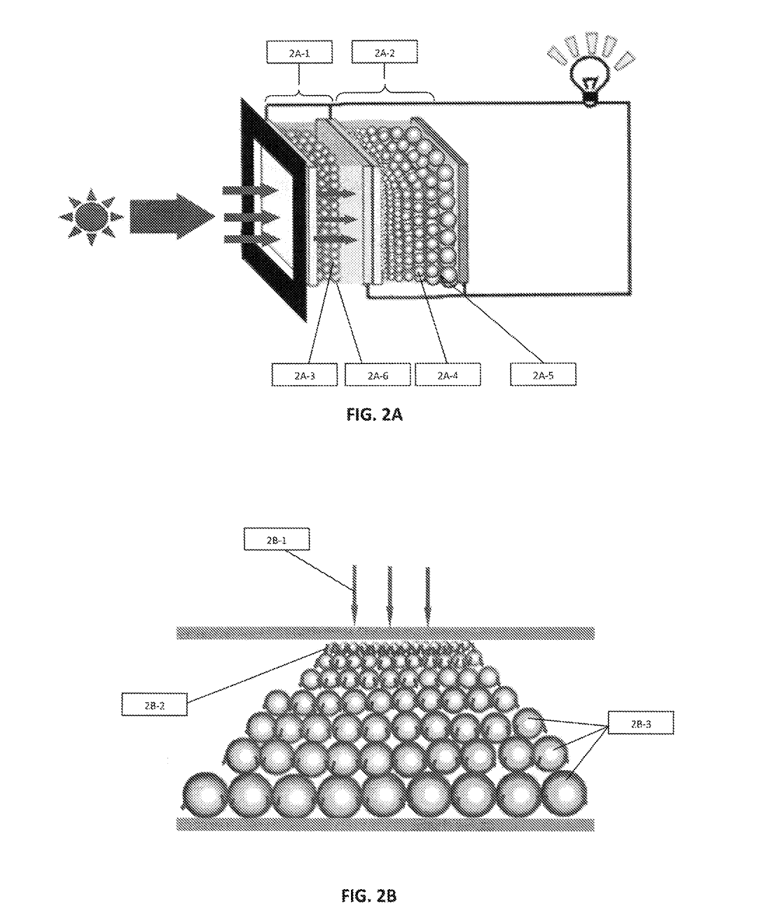

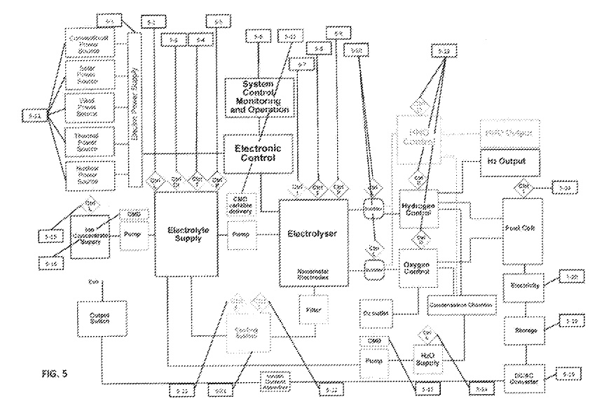

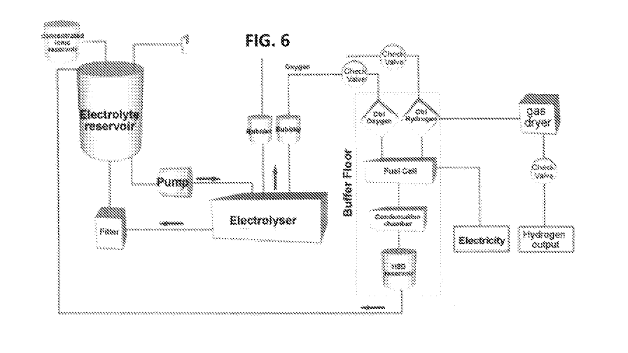

For a complete understanding of the present invention, we will detail all of the figures describing the various points of the system. As shown through FIG. 1, the Nanotic electrolyzer 1-3 (FIG. 1) is supplied with electricity through photovoltaic power 1-1 (FIG. 1). To best optimize the operation and performance of the system, a GSM transmission module 1-9 (FIG. 1) is coupled to the unit for monitoring and control system commands 5-6 (FIG. 5) (detailed in application for a U.S. Pat. No. 0,301,908).

The transmission module GSM 1-9 (FIG. 1) allows the control and management of the system remotely, and can optimize the operation of the photovoltaic module by interpreting a weather report dedicated to this solution by unit monitoring and control system commands 5-6 (FIG. 5). Another innovative aspect of the present invention is the establishment of a system of GPS 1-2 (FIG. 1) which allows the system to locate geographically, and through a solar map of the world embedded or download in the unit for monitoring and control system commands 5-6 (FIG. 5), the self-management system to optimize the operation of the photovoltaic module 1-1 (FIG. 1).

After describing the various solutions to optimize upstream of the Nanotic electrolyzer 1-3 (FIG. 1), we will present the solutions proposed in this invention, to optimize the performance of the Nanotic electrolyzer 1-3 (FIG. 1).

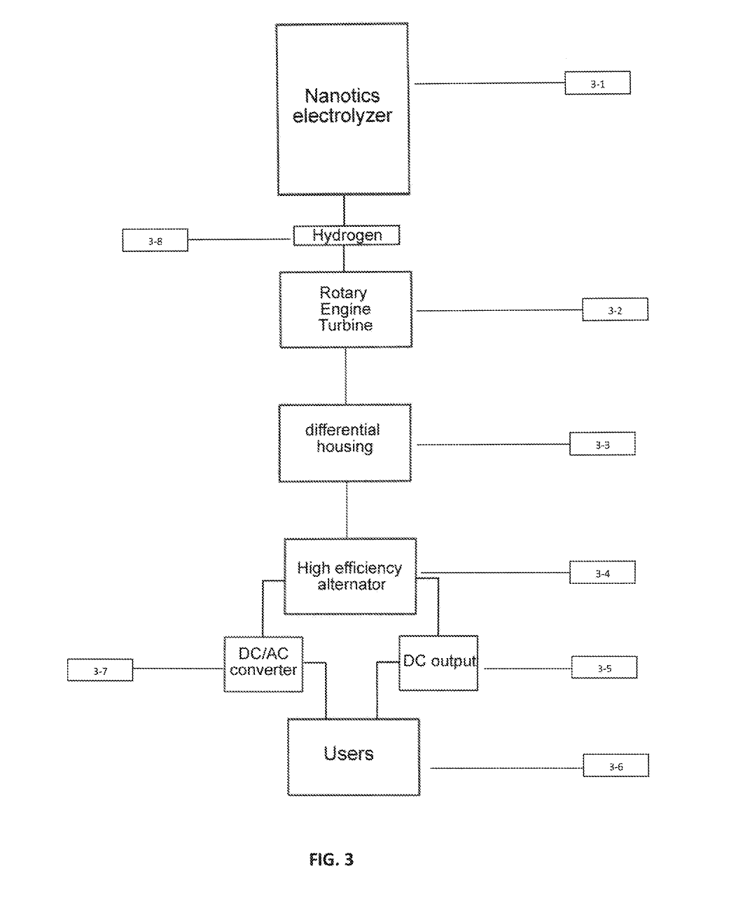

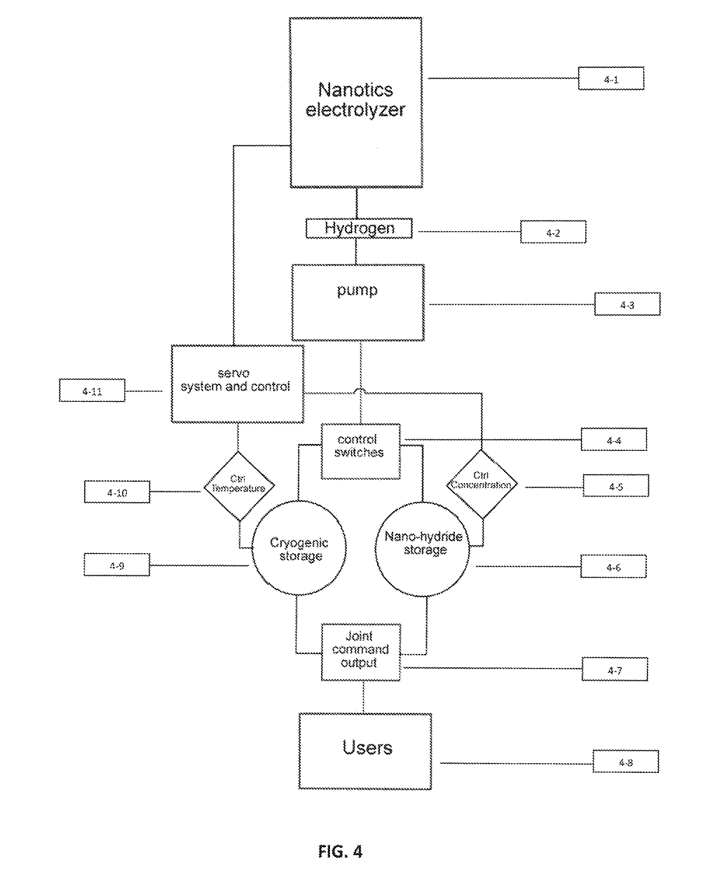

At the exit of the Nanotic electrolyzer 1-3 (FIG. 1) and by the utility, the hydrogen is either i) routed to a storage unit 1-8 (FIG. 1) which stores the hydrogen as a cryogenic 4-9 (FIG. 4), ii) in the form of nano-hydrides 4-6 (FIG. 4), iii) is facing a power module 1-4 (FIG. 1) which provides a high electrical efficiency detailed in FIG. 3.

The photovoltaic power module 1-1 (FIG. 1) consists of two chambers, the first chamber 2A-1 (FIG. 2A) consists of particles of TiO2 coated Nanotic complexes Rutherium 2A-3 (FIG. 2A) to absorb as much visible light rays while letting the other rays.

In the electrolyte chamber 2A-6 (FIG. 2A) is based on the red fluorescent dye-dye (N719), which has an absorption peak at 540 nm to green and the second electrolyte chamber 2A-4 (FIG. 2A) is dye-based black-fluorinated dye (N749) whose peak is 600 nm (orange), but which absorbs up to 800 nm. The invisible IR rays 2B-1 (FIG. 2b) are filtered by the second membrane and enter the second room 2A-2 (FIG. 2A) in which are Nanotic structures of TiO2 2A-5 (FIG. 2A) covered Rutherium complexes in ascending order 2B-3 (FIG. 2b) in size compared to the membrane inlet.

This provision is judiciously used to trap the IR radiation 2B-2 (FIG. 2b), this can lengthen the path of light rays through the cell and thus produce more power. The photoelectric conversion of low wavelengths of the visible spectrum of the first chamber provides a high voltage, that of long wavelength infrared spectrum, the second chamber, providing a strong current, all give rise to the conversion of photo current very high (above 25%).

The power module 1-4 (FIG. 1) as described in FIG. 3, represents an intelligent energy-efficient. Indeed, hydrogen 3-8 (FIG. 3) produced by the electrolyzer Nanot 3-1 (FIG. 3) drives a turbine rotary engine 3-2 (FIG. 3) (Example: Quasi-turbine) to positive displacement with a total displacement volume of neighboring motor which greatly increases the efficiency of the turbine.

The turbine engine rotating 3-2 (FIG. 3) is coupled to a differential box 3-3 (FIG. 3) driving a high performance alternator 3-4 (FIG. 3), this in order to increase the drive speed and rotation of the alternator. The alternator high performance 3-4 (FIG. 3) has an electrical output DC 3-5 (FIG. 3) for direct use 3-6 (FIG. 3) low voltage mode (12 Volts).

To use AC current, high efficiency alternator 3-4 (FIG. 3) is connected to a DC/AC 3-7 (FIG. 3). All of which can be connected to a battery 1-10 (FIG. 1) to store electricity.

The storage unit of hydrogen 1-8 (FIG. 1) as described in FIG. 4 shows a system for storing cryogenic form 4-9 (FIG. 4) or in the form of nano hydrides 4-6 (FIG. 4). Hydrogen 4-2 (FIG. 4) produced by the electrolyzer Nanot 4-1 (FIG. 4) is compressed by a pump 4-3 (FIG. 4) and by controlling switches 4-4 (FIG. 4). The hydrogen is stored either in cryogenic form or as nano hydrides.

A servo control system and control 4-11 (FIG. 4) connected to the unit for monitoring and control system commands 5-6 (FIG. 5) manages the storage of hydrogen by a control system temperature 4-10 (FIG. 4). For cryogenic storage 4-9 (FIG. 4) and for storage Nano Hydrides 4-6 (FIG. 4), the system of enslavement and control 4-11 (FIG. 4) manages the control of concentration of hydrogen in hydrides. To release the hydrogen to the user 4-8 (FIG. 4) Joint command output 4-7 (FIG. 4) controls the flow at the exit.

It is important to note that the present invention is more clearly evidenced by the description of specific embodiments as described. Nevertheless, the object of the invention is not limited to these embodiments described because other embodiments of the invention are possible and can easily be achieved by extrapolation.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An optimized system of clean energy production comprising of at least one electrolysis chamber, electrodes, electrolyte, command(s) with at least one nano scales based materials, nano scale carbon tubes compounds or, such materials include nano metals from 1 to 50 nm or carbon nanotubes, collectively called the nano components, solar cells and/or photovoltaic and independently produce on-demand energy in the form clean hydrogen and/or oxygen and/or electricity.

15. A system of energy production with a cycle of Light-Water-Gas-Water, which optimizes the production of clean electricity using the photon energy from the sun with at least two chambers based capture comprising nanoparticles of titanium dioxide (TiO2) and/or covered by a complex of Rutherium (Ru).

16. An optimized system of energy production comprising of at least one electrolysis chamber, electrodes, electrolyte, command(s) with at least one nano scales based materials or carbon composites tubes or nano scale, such materials including nano metals from 1 to 50 nm, carbon nanotubes or nano hydrides generally called the nano components, solar cells and/or store photovoltaic electricity after his conversion as clean hydrogen in an electrolyzer super effective.

17. A system described in at least one of claim 2 or 3, coupled to a power module that generates power for the aircraft as a low voltage DC.

18. A system described in at least one of claims 1 to 3 in which are placed structures of nanoscale titanium dioxide (TiO2), arranged in ascending order by size in relation to the entrance of the chamber with effect of lengthening the path of light rays to cross the room and creates an amplifying effect.

19. A system described in at least one of claims 1 to 3 in which are placed structures in nanoscale titanium dioxide (TiO2) in separate chambers, each containing an electrolyte-based dye fluorinated N719 (commonly known as Red-Dye, with an absorption peak at 540 nm) and an electrolyte-based dye fluorinated N749 (also called Black-Dye, having an absorption peak at 600 nm).

20. A system composed of several chambers described in at least one of claims 1 to 3 in which at least one chamber captures the tensions by converting low wavelengths while at least one other room picks up the strong current conversion of long wavelengths, and/or high photo current generated is the result of combining strong tension and strong currents and/or, where the rise of energy production is a exponential relationship which is dependent on the number of chambers.

21. A system described in at least one of claims 1 to 3 with a system that increases the efficiency of energy production with multipliers, and this through a turbine rotating hydrogen, coupled or not, a differential system.

23. A system described in at least one of claims 1 to 3 that uses at least one cryogenic storage unit and/or storage-based hydrides which is controlled by an intelligent servo with a flexible arrangement to energy efficient and uses elements nano scales based materials or carbon composites or nano scale tubes, such materials include nano metals from 1 to 50 nm or carbon nanotubes, nano collectively called elements.

24. A system described in at least one of claims 1 to 3 of energy production provided a source of clean hydrogen using solar energy that detects environmental conditions.
